(19) United States
(12) Patent Application Publication
(10) Pub. No.: US 2012/0053975 A1
(43) Pub. Date: Mar. 1, 2012

(54) LOGISTICS AND MANIFEST MANAGEMENT SYSTEM AND METHOD

(76) Inventor: Cecil E. Lohn, JR., Kuala Lumpur (MY)

(21) Appl. No.: 13/216,792

(22) Filed: Aug. 24, 2011

Related U.S. Application Data
(60) Provisional application No. 61/376,445, filed on Aug. 24, 2010.

(51) Int. Cl. G06Q 10/08; G06Q 50/28

(52) U.S. Cl. 705/7.12; 705/28; 705/29

(57) ABSTRACT

A logistics management system and method for organizing and managing the operations of an oil rig or other offshore location. The logistics management system can organize and track boat and helicopter manifests, inventory for onshore and offshore locations, floating stock, and bulk materials. Additionally, the logistics management system can create lists of contact information for personnel, personnel on board particular offshore locations and particular helicopters or boats, items to be transferred from one location to another, operations schedules and timelines, and rental information.

### CROSS-REFERENCE TO RELATED APPLICATIONS

This application claims priority to U.S. Provisional Patent Application No. 61/376,445, filed Aug. 24, 2010 and entitled ONLINE LOGISTICS MANIFEST SYSTEM, the entire contents of which are hereby incorporated by reference.

### BACKGROUND

The offshore oil and gas drilling and production industry requires the transport of significant quantities of personnel, materials and equipment to and from the various facilities, vehicles and vessels involved in the seeking out and retrieval of fossil fuels. Drilling and production operations typically require a significant amount of time to complete, and, during such operations, a particular facility may request to be supplied or resupplied with various materials or equipment in various quantities. Certain personnel involved in the operations may also need to be transferred between various facilities both on expected and on unforeseen occasions. Additionally, a number of drilling and production facilities may be operating at a particular locality or region; vessels involved in support and resupply of such facilities may make multi-stop trips, picking up and dropping off diverse equipment and personnel at each location.

Generally, the tracking of personnel, materials and equipment has been accomplished through the use of manifests and inventory lists, which simply provided a listing of the items or personnel that were onboard a particular vessel. However, such methods of inventory and personnel tracking must be constantly supervised, updated and coordinated between the various facilities involved in the operation. For example, if there are personnel traveling from an onshore facility to an offshore oil rig, the personnel must first be manually added to an outbound manifest at the facility. Subsequently, when the personnel have boarded a desired vessel, their names must be copied from the outbound manifest and placed onto a personnel-on-board list for the rig. Finally, when the personnel have debarked at the oil rig, they must be removed from the rig's personnel on board list, and placed on the inbound manifest coming back to shore base. Thus, such tracking methods require a significant amount of data entry, removal and management, require manual coordination between the various lists, and present a high possibility for the occurrence of errors.

Moreover, other necessary aspects of the logistics of offshore oil and gas production also need to be managed. For example, the departure and arrival times of vessels, as well as the time the vessels spent in transit need to be coordinated so as to forecast and determine which vessels are used to transport which equipment and/or personnel, the estimated arrival times of specific materials to a particular facility, the costs associated with storage, transport, and rental of equipment, and so forth. Such management and coordination of interdependent activities and variables likewise introduces increased chances for errors as well as increased transaction and operating costs. Additionally, such management and coordination is typically carried out by diverse employees at different locations. Therefore, there is an added potential for errors due to mis-synchronization between the various lists, manifests, and schedules involved, as well as due to the difficulty of coordinating between diverse locations. Thus, a centralized way of coordinating the various personnel, equipment and vessels involved in the oil and gas drilling and production industry is desired.

### SUMMARY

According to at least one exemplary embodiment, a logistics and manifest management system is disclosed. The logistics management system can organize and track boat and helicopter manifests, inventory for onshore and offshore locations, floating stock, left-in-well stock, boat daily activity reports, personnel records, service company loadout lists, bulk materials and logistics statistics. Additionally, the logistics management system can create lists of contact information for personnel, personnel on board particular offshore locations and particular helicopters or boats, items to be transferred from one location to another, operations schedules and timelines, and rental information. The logistics management system can also track vessel daily activity reports and airline travel and hotel reservations.

### BRIEF DESCRIPTION OF THE FIGURES

FIG. 1a is an exemplary diagram showing a computer system.

FIG. 1b is an exemplary diagram of a logistics management system.

FIG. 2 is an exemplary main menu interface of a logistics and manifest management system.

FIG. 3a is an exemplary login interface of a logistics and manifest management system.

FIG. 3b is an exemplary signup interface of a logistics and manifest management system.

FIG. 4a is an exemplary permissions page selection interface of a logistics and manifest management system.

FIG. 4b is an exemplary default permissions editing interface of a logistics and manifest management system.

FIG. 4c is an exemplary offshore location permissions editing interface of a logistics and manifest management system.

FIG. 4d is an exemplary onshore location permissions editing interface of a logistics and manifest management system.

FIG. 4e is an exemplary permissions editing interface for a boat daily activity report.

FIG. 5a is an exemplary onshore location management interface of a logistics and manifest management system.

FIG. 5b is an exemplary offshore platform management interface of a logistics and manifest management system.

FIG. 5c is an exemplary vessel management interface of a logistics and manifest management system.

FIG. 5d is an exemplary rig management interface of a logistics and manifest management system.

FIG. 5e is an exemplary helicopter management interface of a logistics and manifest management system.

FIG. 5f is an exemplary well management interface of a logistics and manifest management system.

FIG. 6a is an exemplary bulk materials management interface of a logistics and manifest management system.

FIG. 6b is an exemplary bulk items management and tracking interface of a logistics and manifest management system.

FIG. 6c shows an exemplary bulk item management and tracking process of a logistics and manifest management system.

FIG. 6d is an exemplary bulk transfer loss report interface of a logistics and manifest management system.

FIG. 7a is an exemplary working manifest interface of a logistics and manifest management system.

FIG. 7b is an exemplary final manifest interface of a logistics and manifest management system.

FIG. 8a is an exemplary warehouse inventory interface of a logistics and manifest management system.

FIG. 8b is an exemplary floating stock interface of a logistics and manifest management system.

FIG. 9 is an exemplary loadout list interface of a logistics and manifest management system.

FIG. 10 is an exemplary rental tool tracking interface of a logistics and manifest management system.

FIG. 11a is an exemplary look-ahead sheet interface of a logistics and manifest management system.

FIG. 11b is an exemplary look-ahead calendar interface of a logistics and manifest management system.

FIG. 12 is an exemplary callout list interface of a logistics and manifest management system.

FIG. 13 is an exemplary planning files interface of a logistics and manifest management system.

FIG. 14 is an exemplary contact list interface of a logistics and manifest management system.

FIG. 15a is an exemplary available flights interface of a logistics and manifest management system.

FIG. 15b is an exemplary flight booking interface of a logistics and manifest management system.

FIG. 15c is an exemplary helicopter manifest interface of a logistics and manifest management system.

FIG. 15d is an exemplary flight hours interface of a logistics and manifest management system.

FIG. 16 is an exemplary personnel on board interface of a logistics and manifest management system.

FIG. 17 is an exemplary boat daily activity report interface of a logistics and manifest management system.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

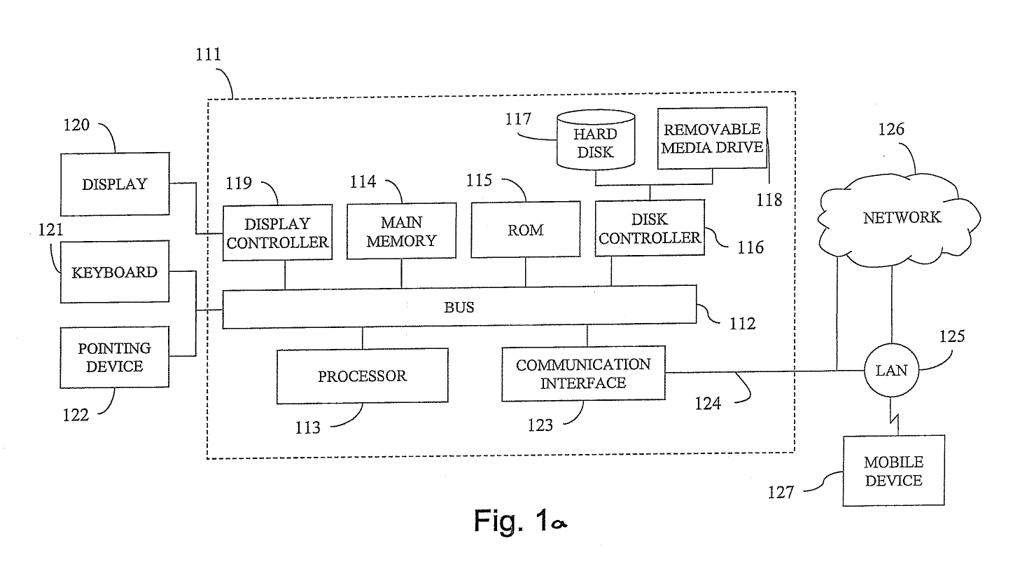

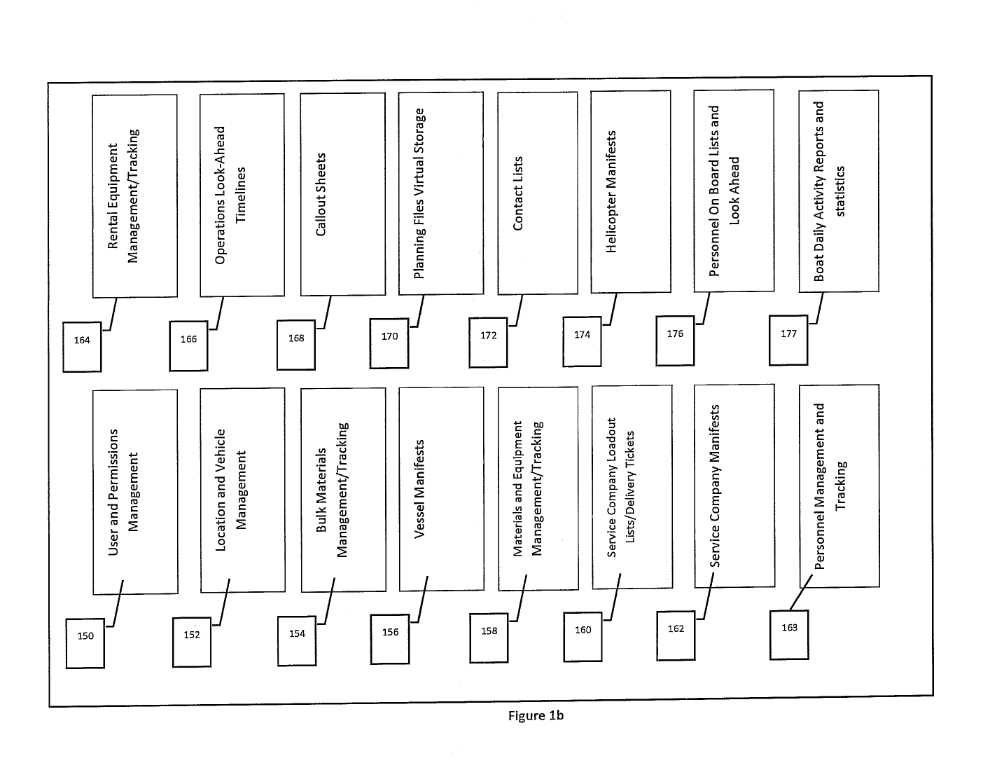

FIG. 1 illustrates a computer system 111 upon which an embodiment of the present invention may be implemented. The computer system 111 includes a bus 112 or other communication mechanism for communicating information, and a processor 113 coupled with the bus 112 for processing the information. The computer system 111 also includes a main memory 114, such as a random access memory (RAM) or other dynamic storage device (e.g., dynamic RAM (DRAM), static RAM (SRAM), and synchronous DRAM (SDRAM)), coupled to the bus 112 for storing information and instructions to be executed by processor 113. In addition, the main memory 114 may be used for storing temporary variables or other intermediate information during the execution of instructions by the processor 113. The computer system 111 further includes a read only memory (ROM) 115 or other static storage device (e.g., programmable ROM (PROM), erasable PROM (EPROM), and electrically erasable PROM (EEPROM)) coupled to the bus 112 for storing static information and instructions for the processor 113.

The computer system 111 also includes a disk controller 116 coupled to the bus 112 to control one or more storage devices for storing information and instructions, such as a magnetic hard disk 117, and a removable media drive 118 (e.g., floppy disk drive, read-only compact disc drive, read/write compact disc drive, compact disc jukebox, tape drive, and removable magneto-optical drive). The storage devices may be added to the computer system 111 using an appropriate device interface (e.g., small computer system interface (SCSI), integrated device electronics (IDE), enhanced-IDE (E-IDE), direct memory access (DMA), or ultra-DMA).

Further, exemplary embodiments include or incorporate at least one database which may store software, descriptive data, system data, digital images and any other data item required by the other components necessary to effectuate any embodiment of the present system known to one having ordinary skill in the art. The database may be provided, for example, as a database management system (DBMS), a relational database management system (e.g., DB2, ACCESS, etc.), an object-oriented database management system (ODBMS), a file system or another conventional database package as a few non-limiting examples. The database can be accessed via a Structure Query Language (SQL) or other tools known to one having skill in the art.

Still referring to FIG. 1, the computer system 111 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 111 may also include a display controller 119 coupled to the bus 112 to control a display 120, such as a cathode ray tube (CRT), liquid crystal display (LCD) or any other type of display, for displaying information to a computer client 204. The computer system includes input devices, such as a keyboard 121 and a pointing device 122, for interacting with a computer client 204 and providing information to the processor 113. Additionally, a touch screen could be employed in conjunction with display 120. The pointing device 122, for example, may be a mouse, a trackball, or a pointing stick for communicating direction information and command selections to the processor 113 and for controlling cursor movement on the display 120. In addition, a printer may provide printed listings of data stored and/or generated by the computer system 111.

The computer system 111 performs a portion or all of the processing steps of the invention in response to the processor 113 executing one or more sequences of one or more instructions contained in a memory, such as the main memory 114. Such instructions may be read into the main memory 114 from another computer readable medium, such as a hard disk 117 or a removable media drive 118. One or more processors in a multi-processing arrangement may also be employed to execute the sequences of instructions contained in main memory 114. In alternative embodiments, hard-wired circuitry may be used in place of or in combination with software instructions. Thus, embodiments are not limited to any specific combination of hardware circuitry and software.

As stated above, the computer system 111 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 111, for driving a device or devices for implementing the invention, and for enabling the computer system 111 to interact with a human client. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 113 for execution. A computer readable medium may take many forms, including but not limited to, non-volatile media, volatile media, and transmission media. Non-volatile media includes, for example, optical, magnetic disks, and magneto-optical disks, such as the hard disk 117 or the removable media drive 118. Volatile media includes dynamic memory, such as the main memory 114. Transmission media includes coaxial cables, copper wire and fiber optics, including the wires that make up the bus 112. Transmission media also may also take the form of acoustic or light waves, such as those generated during radio wave and infrared data communications.

Various forms of computer readable media may be involved in carrying out one or more sequences of one or more instructions to processor 113 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 111 may receive the data on the telephone line and use an infrared transmitter to convert the data to an infrared signal. An infrared detector coupled to the bus 112 can receive the data carried in the infrared signal and place the data on the bus 112. The bus 112 carries the data to the main memory 114, from which the processor 113 retrieves and executes the instructions. The instructions received by the main memory 114 may optionally be stored on storage device 117 or 118 either before or after execution by processor 113.

The computer system 111 also includes a communication interface 123 coupled to the bus 112. The communication interface 123 provides a two-way data communication coupling to a network link 124 that is connected to, for example, a local area network (LAN) 125, or to another communications network 126 such as the Internet. For example, the communication interface 123 may be a network interface card to attach to any packet switched LAN. As another example, the communication interface 123 may be a wireless link. In any such implementation, the communication interface 123 sends and receives electrical, electromagnetic or optical signals that carry digital data streams representing various types of information.

The network link 124 typically provides data communication through one or more networks to other data devices. For example, the network link 124 may provide a connection to another computer or remotely located presentation device through a local network 125 (e.g., an 802.11-compliant wireless network) or through equipment operated by a service provider, which provides communication services through a communications network 126. In preferred embodiments, the local network 124 and the communications network 126 preferably use electrical, electromagnetic, or optical signals that carry digital data streams. The signals through the various networks and the signals on the network link 124 and through the communication interface 123, which carry the digital data to and from the computer system 111, are exemplary forms of carrier waves transporting the information. The computer system 111 can transmit and receive data, including program code, through the network(s) 125 and 126, the network link 124 and the communication interface 123. Moreover, the network link 124 may provide a connection through a LAN 125 to a mobile device 127 such as a personal digital assistant (PDA) laptop computer, or cellular telephone. The LAN communications network 125 and the communications network 126 both use electrical, electromagnetic or optical signals that carry digital data streams. The signals through the various networks and the signals on the network link 124 and through the communication interface 123, which carry the digital data to and from the system 111, are exemplary forms of carrier waves transporting the information. The processor system 111 can transmit notifications and receive data, including program code, through the network(s), the network link 124 and the communication interface 123.

Other aspects of the invention may include data transmission and Internet-related activities. See Preston Gralla, How the Internet Works, Ziff-Davis Press (1996), which is hereby incorporated by reference into this patent application. Still other aspects of the invention may utilize wireless data transmission, such as those described in U.S. Pat. Nos. 6,456,645, 5,818,328 and/or 6,208,445, all of which are hereby incorporated by reference into this patent application.

FIG. 1b shows an exemplary diagram of a logistics management system 100. Logistics management system 100 may include various capabilities. Such capabilities may include, but are not limited to, user and permission management 150, location and vehicle management 152, bulk materials management and tracking 154, vessel manifest management 156, materials and equipment management and tracking 158, service company loadout list and delivery ticket management 160, service company manifest management 162, personnel management and tracking 163, rental equipment management and tracking 164, operations look-ahead timeline management 166, callout list management 168, planning file virtual storage and management 170, contact list management 172, helicopter manifest management 174, personnel-on-board and look-ahead list management 176, and boat daily activity reports 177. The capabilities of system 100 are described in further detail herein. Additional capabilities may be contemplated and included in system 100 as desired. System 100 may further be an Internet-based database, and may be accessible from any worldwide location.

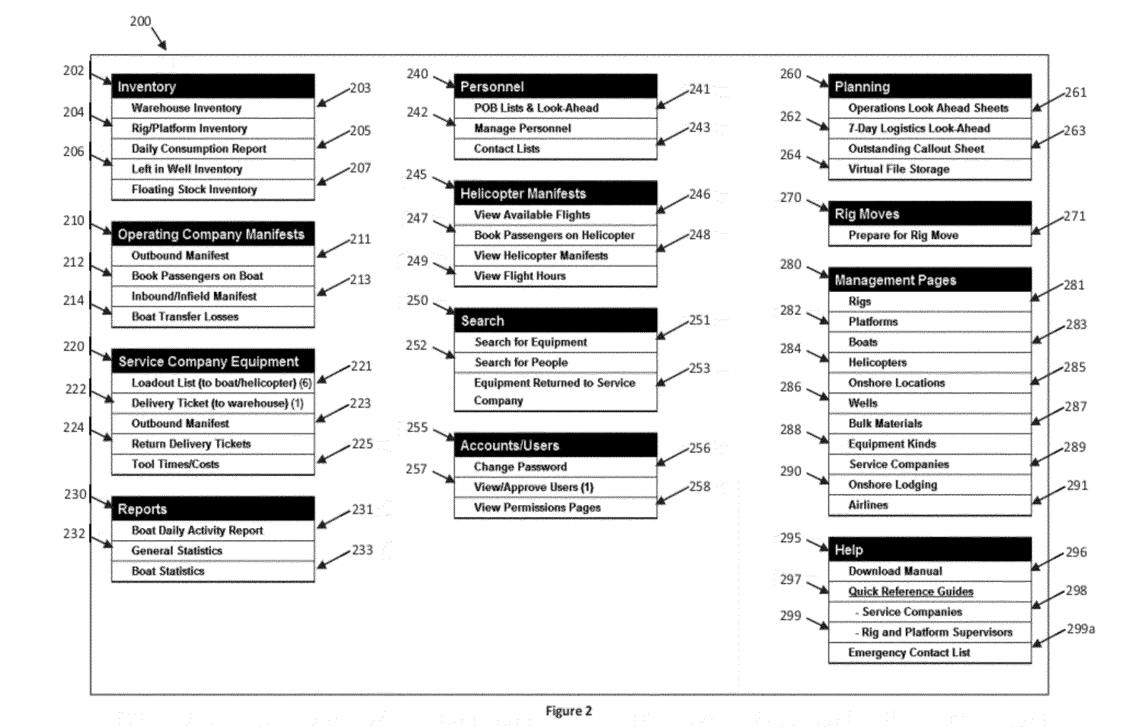

FIG. 2 shows an exemplary main menu interface 200 of a logistics management system 100. Main menu interface 200 can include a plurality of portions showing the various capabilities of system 100 and providing user-selectable links to the capabilities. Such user selectable links may be grouped into general categories of capabilities of system 100. For example, main menu interface 200 can display fields having groups of links related to inventory management capabilities 202, operating company manifest management capabilities 210, service company equipment management capabilities 220, reports 230, personnel management capabilities 240, helicopter manifest management capabilities 245, search capabilities 250, account and user management capabilities 255, planning and look-ahead capabilities 260, rig move management capabilities 270, location and vehicle management capabilities 280, and user help capabilities 295.

Inventory group 202 can include links to the inventory tracking and management capabilities of system 100, such as, for example, warehouse inventories 203, rig/platform inventories 204, daily consumption reports 205, left-in-well inventories 206, and floating stock inventories 207. Operating company manifest portion 210 can include links to the operating company manifest management and tracking capabilities of system 100 such as, for example, outbound manifests 211, inbound/infield manifests 213, loss reports 214, and passenger booking onto boats 212. Service company equipment group 220 can include links to the service company equipment management and tracking capabilities of system 100 such as, for example, loadout lists 221, delivery tickets to warehouses 222, outbound manifests 223, return delivery tickets 224, and tool times and costs 225. Reports group 230 can include links to the boat daily activity reports and statistics capabilities of system 100. Personnel group 240 can include links to the personnel tracking and management capabilities of system 100 such as, for example, personnel-on-board lists and look-ahead lists 241, personnel list management 242, and contact lists 243. Helicopter manifest group 245 can include links to the helicopter manifest management and tracking capabilities of system 100 such as, for example, viewing available flights 246, booking flights 247, viewing helicopter manifests 248, and viewing flight hours 249. Search portion 250 can include links to the search capabilities of system 100 such as, for example, equipment search 251, people search 252, and view equipment returned to service company 253. Account and user portion 255 can include links to the account and user management and tracking capabilities of system 100 such as, for example, password change 256, users viewing and approval 257, and permissions pages viewing 258. Planning and look-ahead portion 260 can include links to the planning and look-ahead capabilities of system 100 such as, for example, operations look ahead sheets 261, 7-day logistics look-ahead 262, outstanding callout sheets 263, and virtual file storage 264. Rig move portion 270 can include links to the rig moving features of system 100 such as, for example, procedures to prepare for rig move 271. Location and vehicle management portion 280 can include links to the location and vehicle management capabilities of system 100 such as, for example, rig management 281, platform management 282, boat management 283, helicopter management 284, well management 286, bulk material management 287, equipment kind management 288, service company lists 289, onshore lodging management 290, and airline booking management 291. User help portion 295 can include links to the user help features of system 100 such as, for example, user manual download 296, quick reference guides 297, and emergency contact lists 299a. A user may select a link for a particular capability to be taken to the corresponding interface for that capability. Additional capabilities and links thereto may be added as desired by the operators of system 100, and the capabilities and features listed herein should be understood as merely exemplary and non-limiting.

User and Permissions Management

Logistics management system 100 may allow for a plurality of operating companies, countries, and divisions to be registered therewith. An operating company may be any organization involved in the oil and gas production industry, or any other desired organization. The operating companies registered with system 100 may have operations in various parts of the world, and each such operation may be subdivided into various divisions. System 100 can therefore provide, if desired, separate accounts and/or databases for each geographic location and each division thereof. System 100 may further keep the data related to a particular division of a particular geographic location of a particular operating company separate from all other divisions, countries, and operating companies, thereby preventing any data conflicts between the various clients of logistics management system 100.

System 100 may include several categories of individuals registered therewith, such as super-users, users and non-users. Certain categories of individuals may be assigned based on the job title of the particular individual. To that end, system 100 may include a list of job titles that may be assigned non-user capabilities, job titles that may be assigned user capabilities and job titles that may be assigned super-user capabilities. Non-users of system 100 may be individuals that are registered with system 100 but do not have permissions to access system 100. Such individuals may be individuals who are working at a particular location or locations, and therefore would need to be registered with the system so that system 100 may track the location of such individuals, but that do not need to access or interact with system 100. The registration of such individuals with system 100 may also allow the individuals to be added to various manifests, for example boat or helicopter manifests, that are used within system 100 and that further facilitate tracking the individuals as they travel between various locations. The registration of such individuals with system 100 may also allow users of the system to track certificates for these individuals if desired.

Individuals having certain job titles may be registered as users of system 100. The user permissions for such users may be based on a default set of permissions for a particular job title, or may be individually edited for any desired user. Job titles for users of the system may fall into several classes. For example, such classes may include: onshore personnel, offshore personnel on rigs, onshore port personnel, and offshore personnel on platforms. The onshore personnel class may include job titles such as drilling manager, drilling superintendent, and drilling engineer. The offshore personnel on rigs class may include job titles such as rig supervisor, night rig supervisor, radio operator, and rig materials man. The onshore port personnel class may include job titles such as port logistics manager, helicopter coordinator, and service company employee. The offshore personnel on platforms class may include job titles such as offshore installation manager, platform materials man, platform helicopter coordinator, and platform production manager. Other classes of users and other job titles may be added to system 100 as desired; thus the examples given above should be considered exemplary and non-limiting.

Certain users, classes of users, or users having particular job titles may have super-user capabilities. Users having super-user capabilities may have permissions to edit other users' permission pages. Conversely, users who do not have the permissions to edit permission pages may only be able to view permissions pages. User job titles having super-user capabilities by default may include drilling superintendent, drilling engineer, and port logistics manager. Other user job titles may be granted super-user capabilities as desired. System 100 may also be configured so as not to assign super-user capabilities by default.

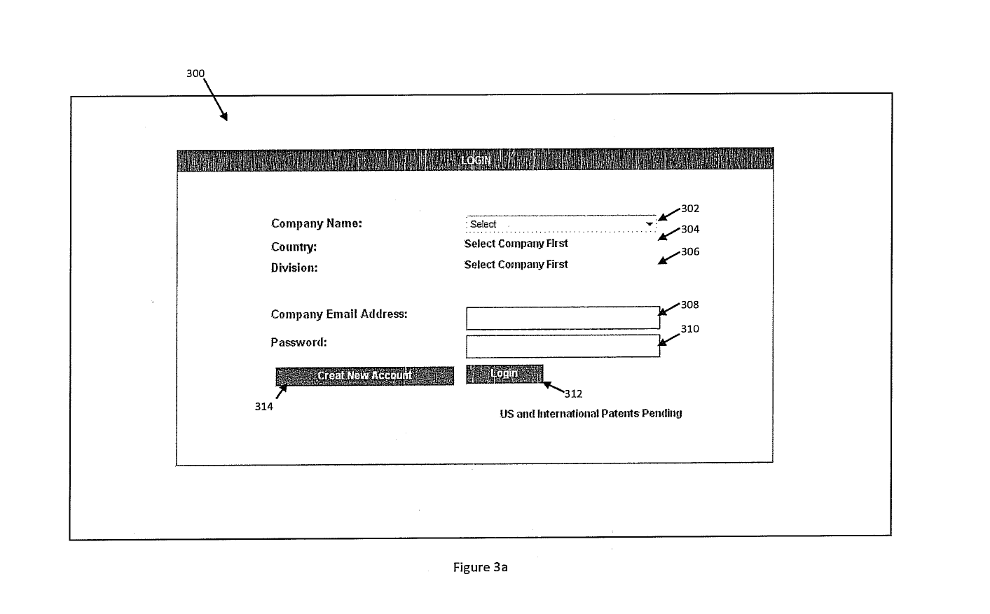

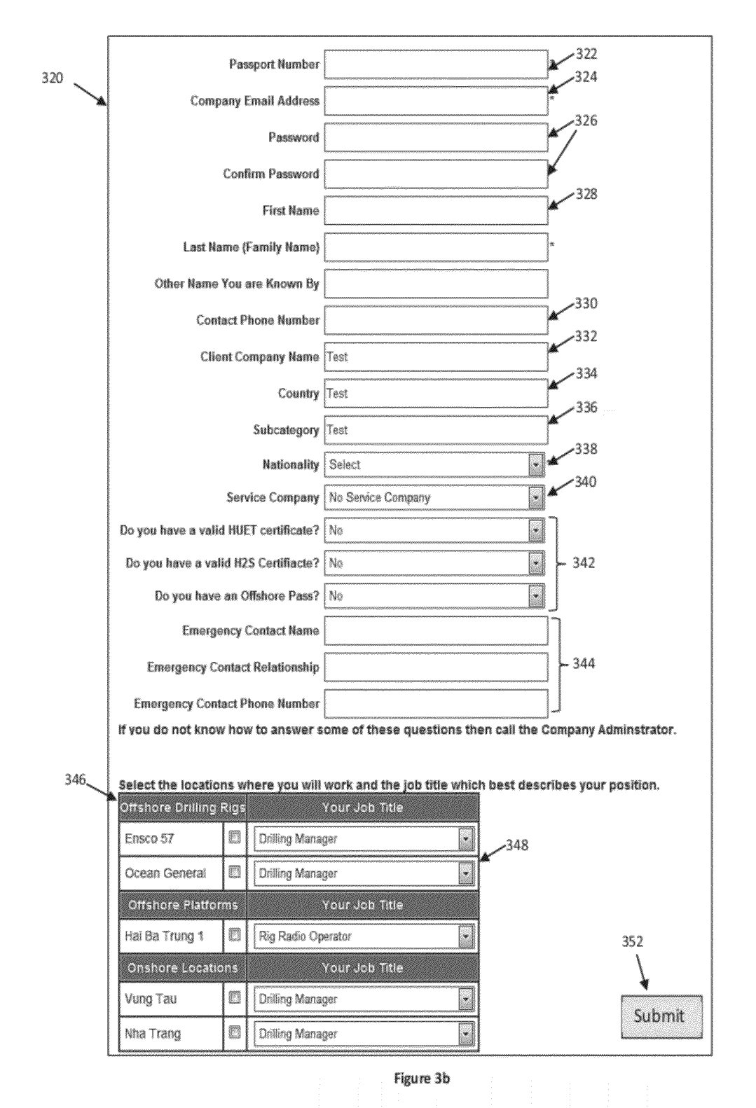

FIG. 3a shows an exemplary embodiment of a login interface 300 of logistics management system 100. Login interface 300 may include entry fields for operating company 302, country 304, and division 306. Login interface may further include therein user account information such as user email address 308 and user password 310. A user of system 100 may thus select a desired operating company, country, and division, and may subsequently enter email and password data so as to log into system 100 using login widget 312. A user of system 100 may also create a new account using new account widget 314.

If a user or operator of system 100 chooses to register a new account with system 100, they may be presented with a signup interface. FIG. 3b shows an exemplary signup interface 320 for logistics management system 100. Sign up interface 320 may include therein a plurality of fields for entry of various personal information pertaining to the user of the new account. Such personal information may include passport number 322, email address 324, password 326, name 328, phone number 330, company name 332, country 334, division 336, nationality 338, service company (if applicable) 340, certificate information 342, emergency contact information 344, and any other personal information that may be desired by users and operators of system 100. Signup interface 320 may further include information regarding the locations 346 where the user of the new account is expected to be present, as well as the corresponding job titles 348 that the user of the new account may have at each selected location. Signup interface 320 may further include a plurality of questions 350 that the user may need to answer so as to facilitate setting proper access permissions for the various capabilities of system 100, for the particular user. Such questions may pertain to the tasks and responsibilities that the user may have aboard any of the selected locations. The particular information, location information, and questions displayed in signup interface 320 may be varied as desired by the users and operators of system 100. Once all pertinent information has been entered, the user may select submit widget 352 to register the new account with system 100. The information entered into interface 320 may be used by the various aspects, capabilities and modules of system 100 to track and identify the user, for example on helicopter manifests, vessel manifests, personnel-on-board lists, and any other capabilities of system 100 where such information is desired. Subsequent to the registration of a new account with system 100, the entered information may be presented to a super-user of system 100 for approval via an interface substantially similar to signup interface 320, or any other desired interface that allows system 100 to function as described herein.

Logistics management system 100 can further include various classes of users, and the capability to set default user permissions for all users, default user permissions for each class of users, default user permissions for users assigned to particular locations, and individual permissions for each user. The classes of users included in system 100 may be represented by the users' job titles. Permissions may also be assigned to users based on a location where the particular users will be working. Additionally, super users may have permissions granted to regular users, as well as additional permissions to manage user accounts, user job titles, and any other desired capabilities relating to the administration and management of logistics management system 100.

Each location registered with system 100 may include its own permissions page. The permissions for all individuals working at the particular location may be set by default according to class or job title, and according to the type of location. System 100 may include at least four types of permissions pages: default permissions, permissions for rig locations, permissions for onshore locations, permissions for onshore locations, and permissions for offshore locations such as vessels. Additional permissions pages may include a permissions page controlling which users of system 100 may register and manage locations and vehicles with system 100.

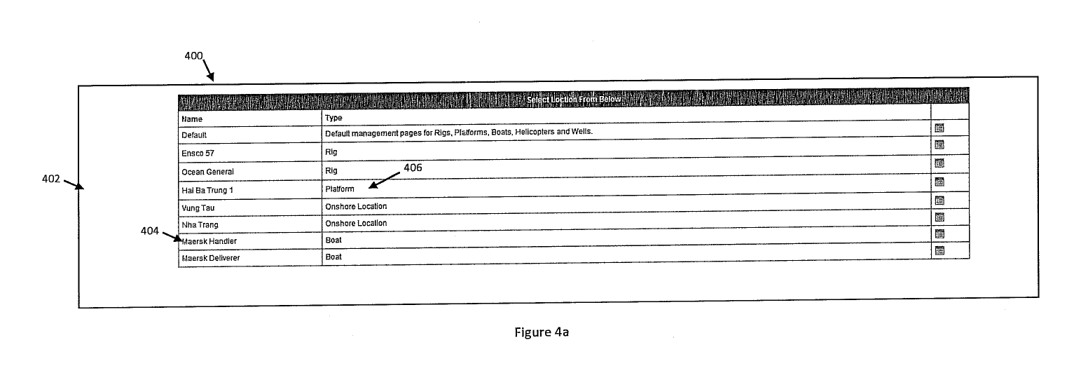

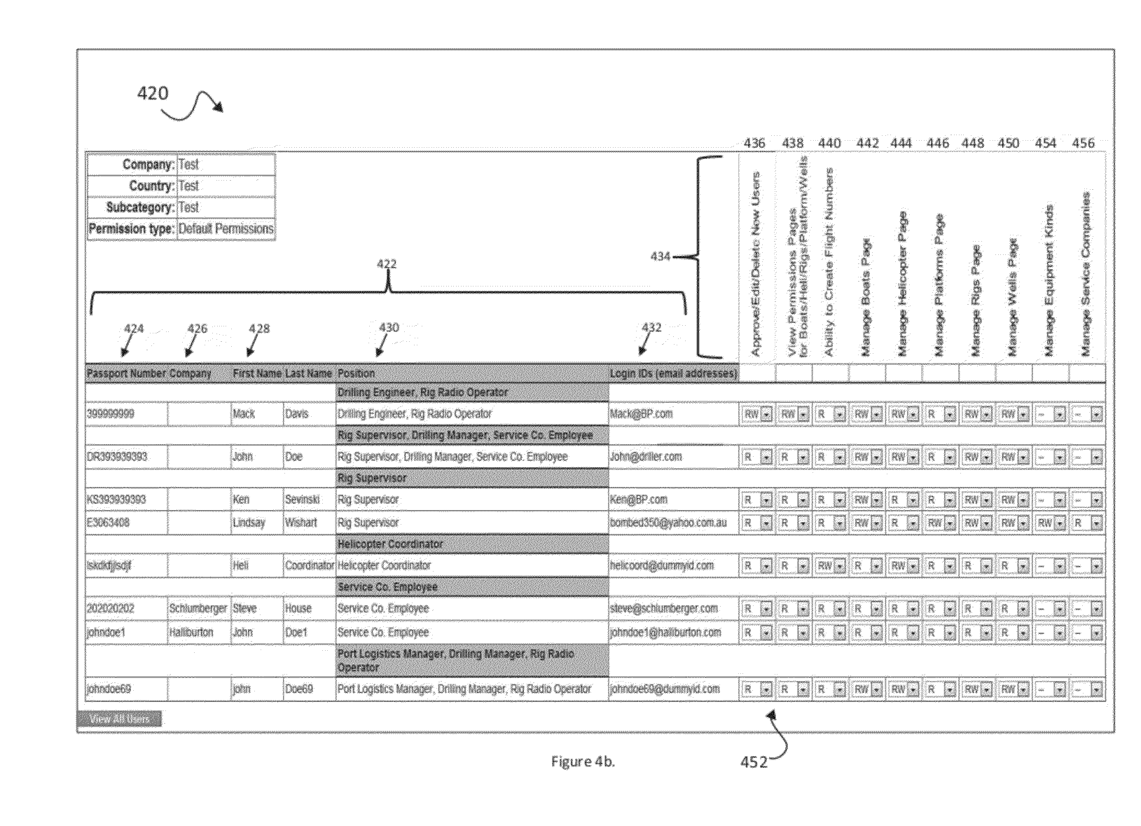

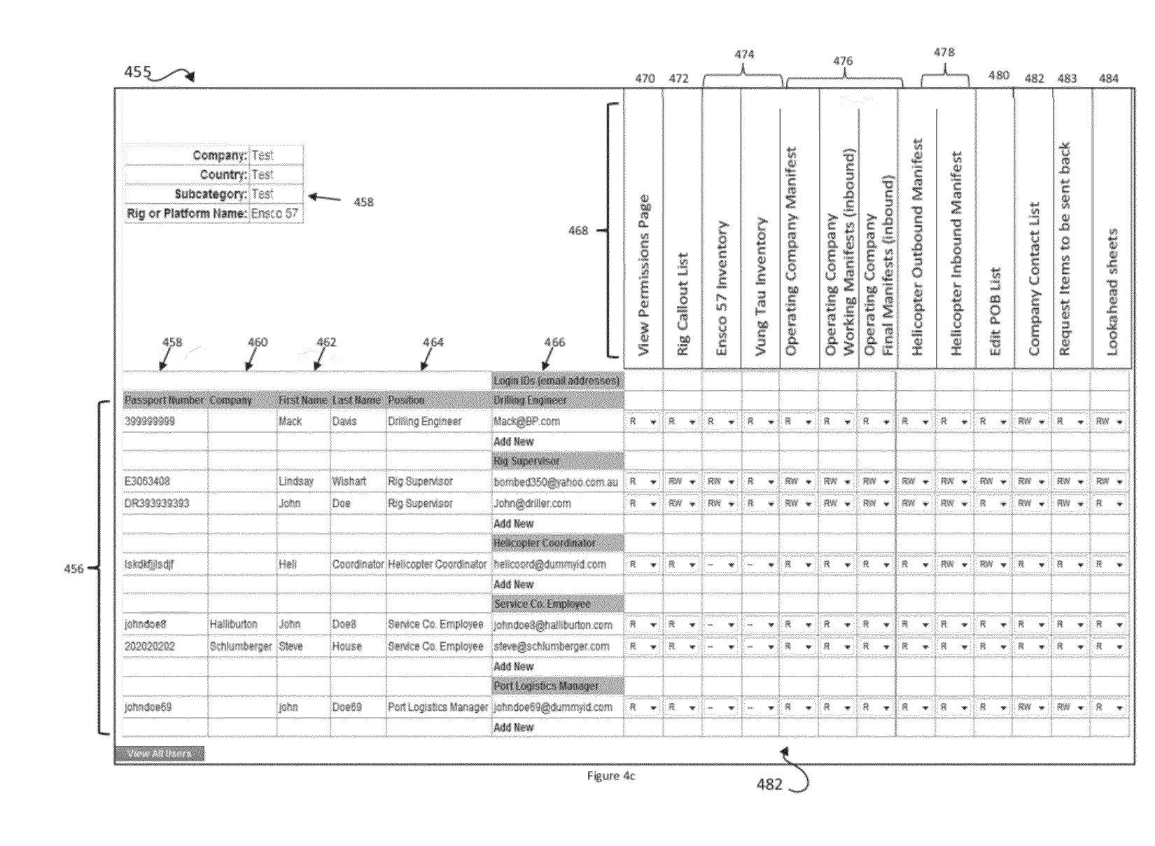

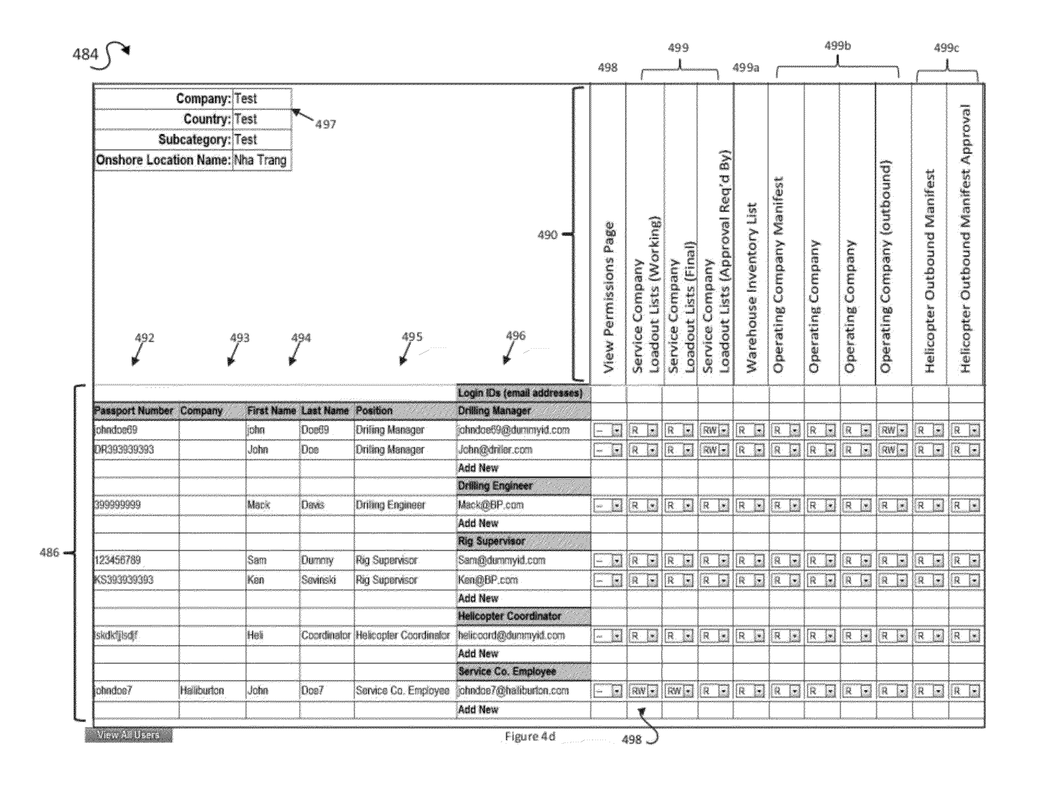

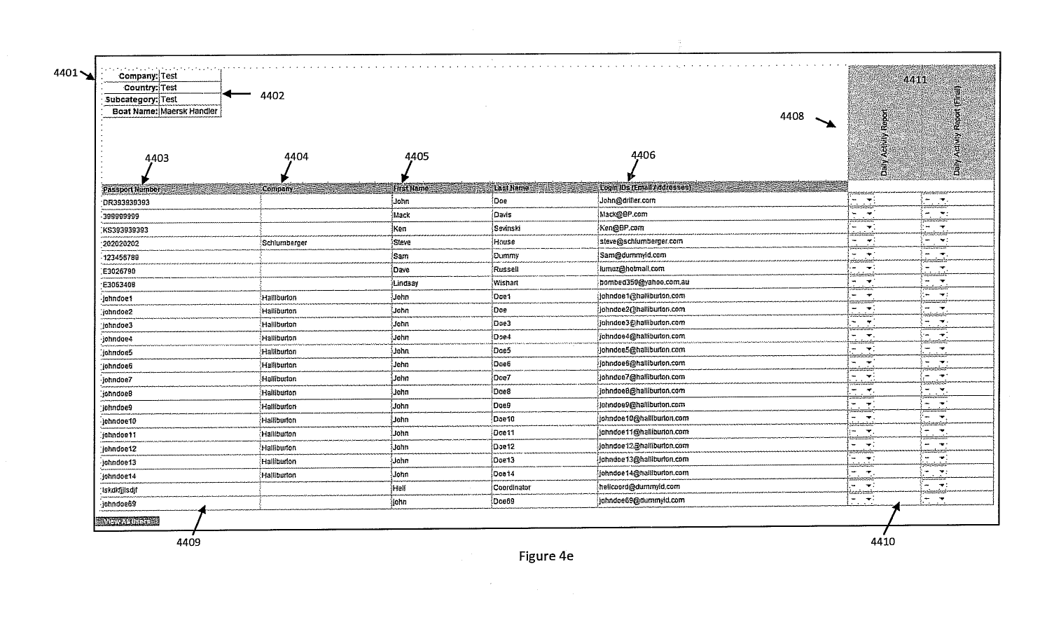

FIG. 4a shows an exemplary permissions page selection interface 400. Permissions page selection interface may include a permissions page list 402. Permissions page list 402 may include a listing of all permissions pages that are present in system 100 and the corresponding permission page types. For each permissions page therein, permissions page list 402 may display the permissions page name 404 and the corresponding permissions page type 406. A user may select a desired permissions page to go to the permissions editing interface for that particular permissions page.

FIG. 4b shows an exemplary default permissions editing interface 420. Default permissions editing interface 420 may include a user list portion 422, an activity list portion 434, and a permissions editing portion 452. User list portion 422 may provide a list of all users that are registered with system 100. For each user therein, user list portion 422 may include user details such as passport number 424, company 426, name 428, job title 430, and login ID 432. Activity list portion 434 may provide a list of the activities for which permissions may be changed for each user. Such activities may include accessing the approve/edit/delete users interface 436, accessing the permissions pages for boats/locations 438, accessing the flight manifest creation interface 440, accessing the boat management interface 442, accessing the helicopter management interface 444, accessing the platform management interface 446, accessing the rigs management interface 448, and accessing the wells management interface 450. Other permissions categories may be added or removed as desired. Permissions editing portion 452 may allow for granularity in the editing of the permission settings for each activity shown in activities list portion 434, for each user displayed in user list portion 422. Such granularity can provide for limiting permissions to read (view), read-write (edit), or none (forbidden), for each activity or interface page listed.

FIG. 4c shows an exemplary permissions editing interface for an offshore location 455. Offshore location permissions editing interface 455 may include a user list portion 456, an activity list portion 468, and a permissions editing portion 482. User list portion 456 may provide a list of all users that are registered with system 458 for the particular offshore location. For each user therein, user list portion 456 may include user details such as passport number 458, company 460, name 462, job title 464, and login ID 466. Additionally, user list portion may be sorted according to criteria such as job title, or any other desired criteria. Activity list portion 468 may provide a list of the activities for which permissions that may be changed for each user. Such activities may include viewing/managing permissions pages 470, callout sheets 472, offshore location inventories 474, operating company manifests 476, helicopter manifests 478, personnel-on-board lists 480, and any other desired aspect of system 100 that is related to offshore locations. Other permissions categories may be added or removed as desired. Permissions editing portion 482 may allow for granularity in editing the permission settings displayed in activity list portion 468 for each user displayed in user list portion 456. Such granularity can provide for limiting permissions to read (view), read-write (edit), or none (forbidden), for each activity or interface page listed.

FIG. 4d shows an exemplary permissions editing interface for an onshore location 484. Onshore location permissions editing interface 484 may include a user list portion 486, an activity list portion 492, and a permissions editing portion 498. User list portion 486 may provide a list of all users that are registered with system 100 for the particular location. For each user therein, user list portion 489 may include user details such as passport number 492, company 493, name 494, job title 495, and login ID 496. Additionally, user list portion may be sorted according to criteria such as job title, or any other desired criteria. Permissions list portion 490 may provide a list of the permissions that may be changed for each user. Such permissions may include options for viewing/editing permissions pages 498, viewing/managing service company loadout lists 499, warehouse inventory lists 499a, operating company manifests 499b, helicopter manifests 499c, and any other desired aspect of system 100 that is related to onshore locations. Other permissions categories may be added or removed as desired. Permissions editing portion 490 may allow for granularity in editing of the permissions setting displayed in activity list portion 491 for each user displayed in user list portion 486. Such granularity can provide for limiting permissions to read (view), read-write (edit), or none (forbidden), for each activity or interface page listed.

FIG. 4e shows an exemplary permissions editing interface for a boat daily activity report 4401. Onshore location permissions editing interface 4401 may include a user list portion 4409, a permissions list portion 4408, and a permissions editing portion 4410. User list portion 4409 may provide a list of all users that are registered with system 100 who need access to the boat activity reports. For each user therein, user list portion 4409 may include user details such as passport number 4403, company 4404, name 4405, and login ID 4406. Additionally, user list portion may be sorted according to criteria such as job title, or any other desired criteria. Permissions list portion 4410 may provide a list of the permissions that may be changed for each user.

Location and Vehicle Management

Logistics management system 100 can include the capability to manage, and track any desired number of locations and vehicles. Non-limiting examples of such locations may be offshore locations such as platforms, drilling rigs and wells, may be onshore locations such as warehouses and ports, or may be any other location used in the industry. Non-limiting examples of vehicles may include vessels and ships, helicopters, trucks, and any other vehicle that can be utilized in the drilling and production industry.

A user having the requisite permissions can register any desired location or vehicle with logistics management system 100. System 100 may then display and utilize the registered vehicles and locations in the various modules and capabilities of system 100 that are described herein. System 100 can further track and record any pertinent information, data and statistics for all registered locations and vehicles.

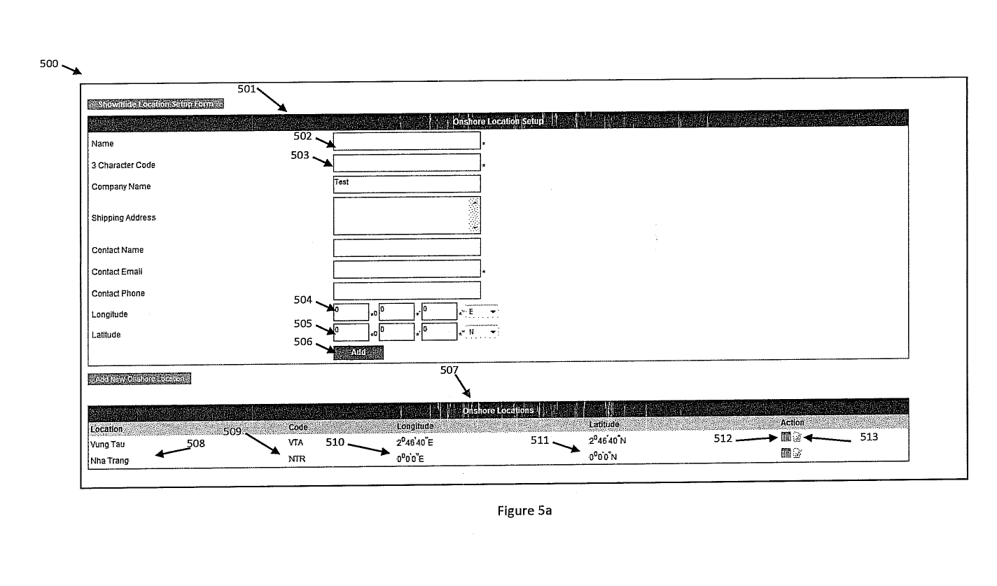

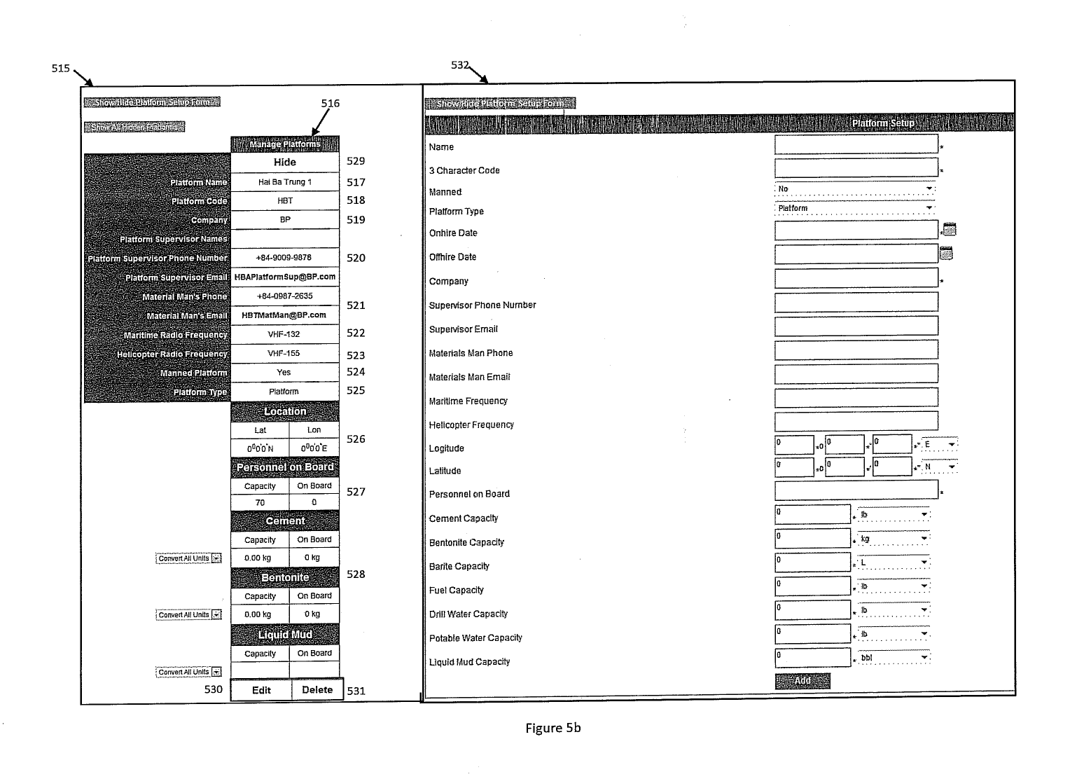

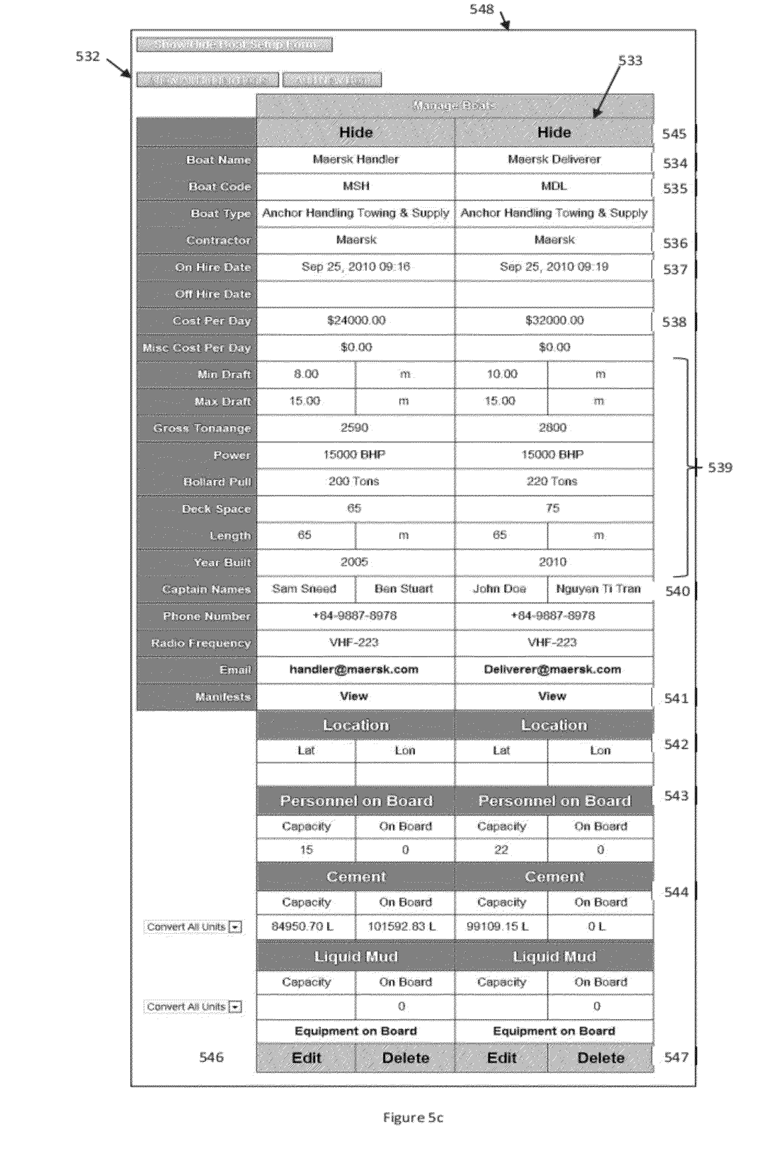

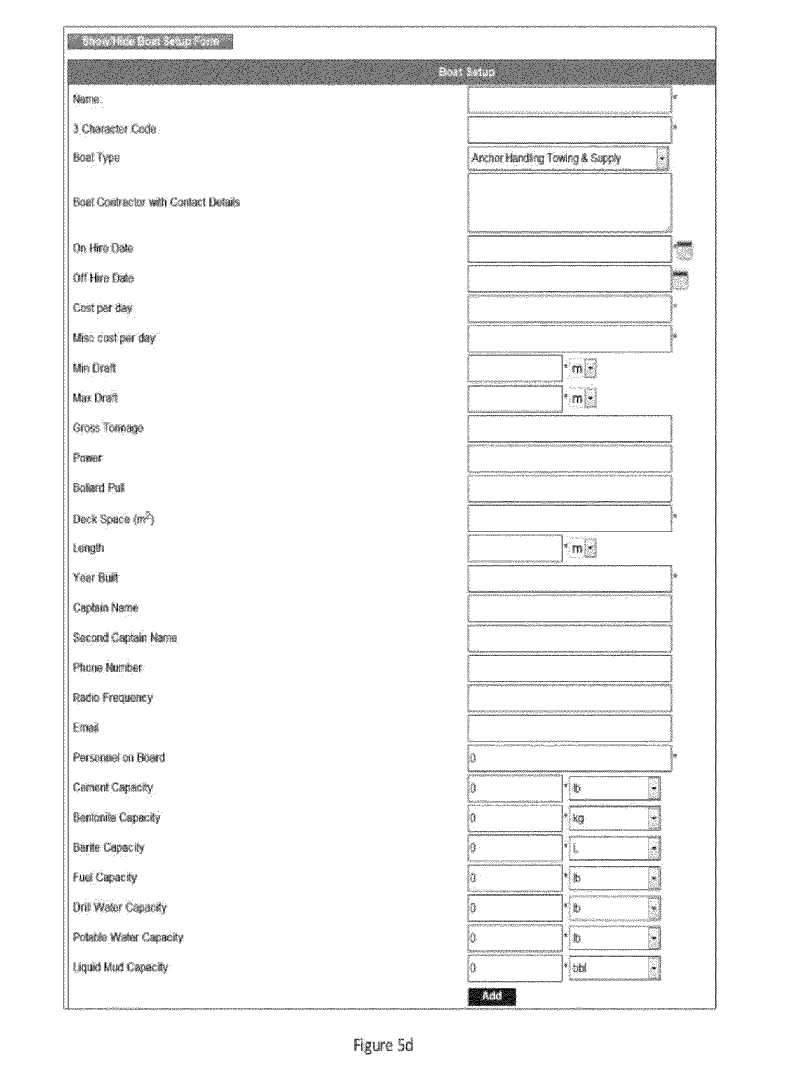

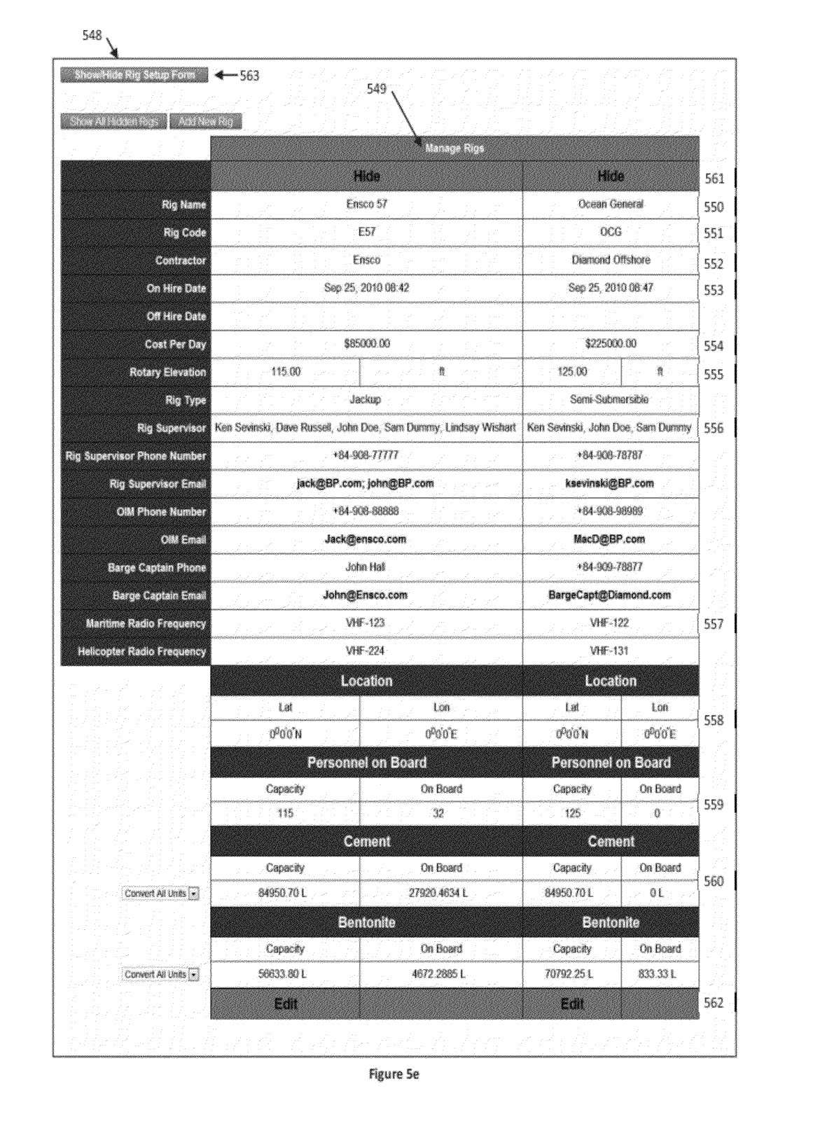

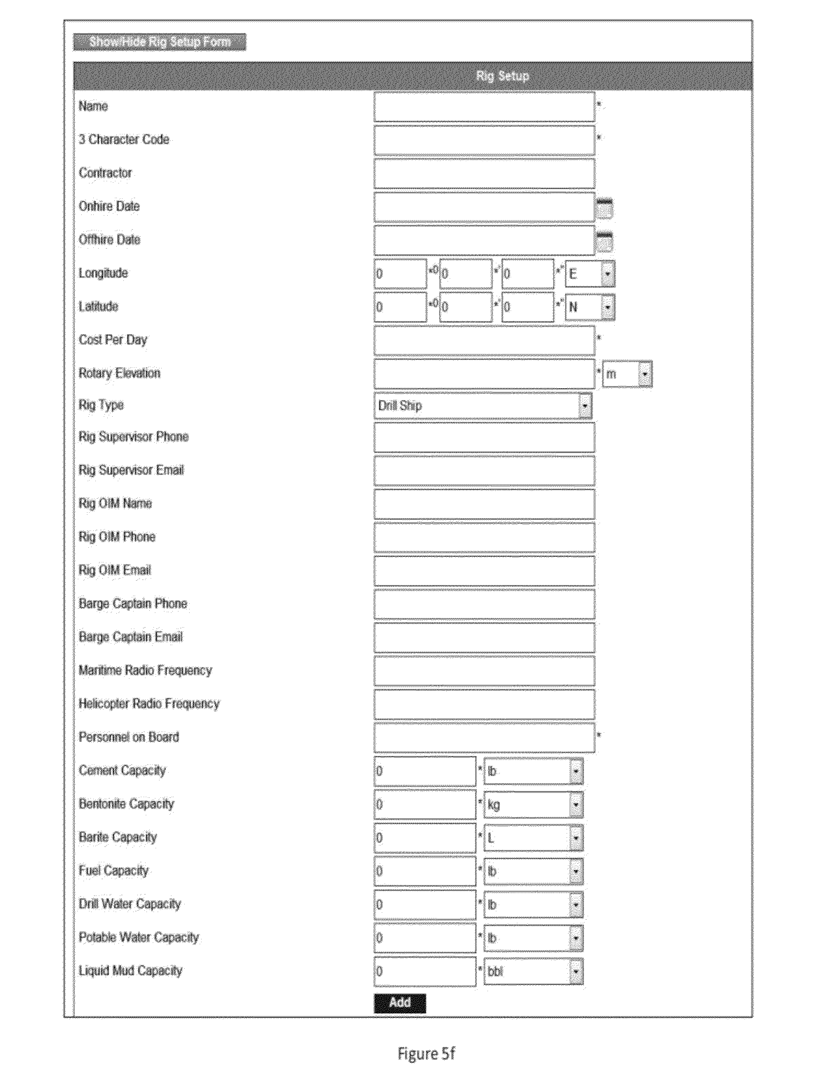

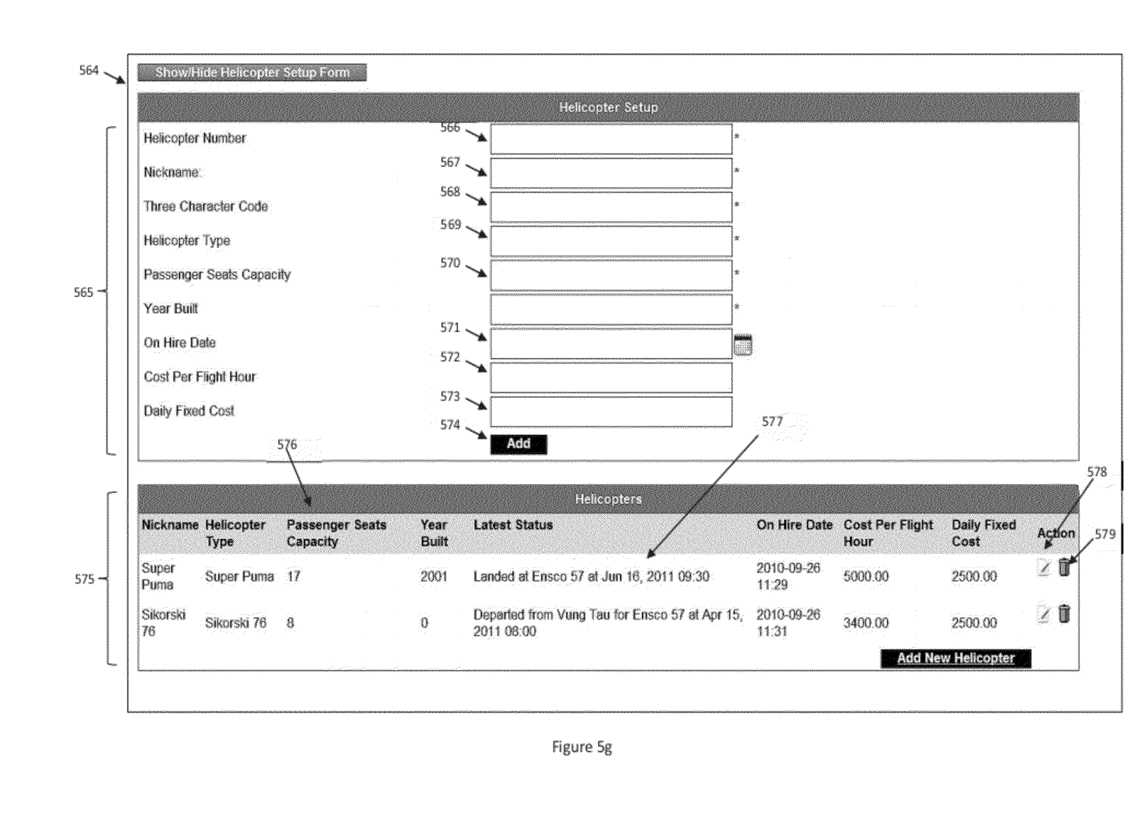

FIG. 5a shows an exemplary onshore location management interface 500 for a logistics management system 100. Onshore location management interface 500 can include a location setup portion 501 and a location list 507. Location setup portion 501 can include fields for location name 502, location code 503, longitude 504 and latitude 505. After a user enters the pertinent information for a particular onshore location, the user may click add widget 506 so as to register the new location with system 100. Location list 507 can display a listing of all locations that are registered with system 100. Location list 100 may include, for every location listed therein, location name 508, location code 509, longitude 510, latitude 511, edit widget 512 and delete widget 513. A user may select edit widget 512 to change information for any desired location via setup portion 501. A user may also select add new location widget 514 to display setup portion 501 so as to create a new location and edit pertinent information for the new location via setup portion 501.

FIG. 5b shows an exemplary offshore platform management interface 515 for a logistics management system 100. Offshore platform management interface 515 can include a platform list 516. For every platform registered with system 100, platform list 516 can include pertinent information, such as: platform name 517, platform code 518, company 519, platform supervisor name and contact information 520, material man's contact information 521, maritime radio frequency 522, helicopter radio frequency 523, manned platform 524, and platform type 525. For every platform registered with system 100, platform list 516 can further include platform latitude and longitude 526, personnel on board and personnel capacity 527, and bulk materials on board and capacity 528. The bulk materials listed may be, as a non limiting example, cement, bentonite, barite, fuel, drill water, potable water, or any other desired bulk materials that are registered with system 100. For every platform registered with system 100, platform list 516 can further include show/hide widget 529, edit widget 530 and delete widget 531. The user can thus show or hide a desired platform on list 516, edit the pertinent information for that platform, or delete the platform from system 100. Selecting edit widget 530 can display platform setup/edit interface 532.

FIG. 5c shows an exemplary vessel management interface 532 for a logistics management system 100. Vessel management interface 532 can include a vessel list 533. For every vessel registered with system 100, vessel list 533 can include pertinent information, such as: vessel name 534, vessel code 535, vessel contractor 536, on-hire and off-hire dates 537, cost per day 538, physical characteristics of the vessel 539 (such as, for example, minimum and maximum draft, gross tonnage, power, bollard pull, deck space, boat length, and/or any other desired physical characteristics) and captain names and contact information 540. For every vessel registered with system 100, vessel list 533 can also include manifest widget 541, which the user can select in order to view corresponding manifests for the particular vessel. For every vessel registered with system 100, vessel list 533 can further include vessel location 542, personnel capacity and personnel currently on board 543, and bulk materials currently on board and capacity 544. For every vessel registered with system 100, vessel list 533 can further include show/hide widget 545, edit widget 546 and delete widget 547. The user can thus show or hide a desired vessel on list 533, edit the pertinent information for that vessel, or delete the vessel from system 100. Selecting edit widget 546 can display platform setup/edit interface 548.

FIG. 5d shows an exemplary rig management interface 548 for a logistics management system 100. Rig management interface 548 can include a vessel list 549. For every rig registered with system 100, rig list 549 can include pertinent information, such as: rig name 550, rig code 551, rig contractor 552, on-hire and off-hire dates 553, cost per day 554, physical characteristics of the rig 555 (such as, for example, rotary elevation, rig type, and/or any other desired physical characteristics) personnel names and contact information 556 (for example, for the rig supervisor, offshore installation manager, barge captain, and/or any other desired personnel) and maritime and helicopter radio frequencies 557. For every rig registered with system 100, rig list 549 can further include rig location 558, personnel capacity and personnel on board 559, and bulk materials on board and capacity 560. For every vessel registered with system 100, rig list 548 can further include show/hide widget 561, and edit widget 562. widget The user can thus show or hide a desired rig on list 548, or edit the pertinent information for that rig. Selecting edit widget 562 can display platform setup/edit interface 563.

FIG. 5e shows an exemplary helicopter management interface 564 for a logistics management system 100. Helicopter management interface 564 can include a helicopter setup portion 565 and a helicopter list 575. Helicopter setup portion 565 can include fields for entering pertinent information, such as: helicopter number 566, helicopter nickname 567, helicopter code 568, helicopter type 569, seating capacity 570, on hire date 571, flight hour cost 572, and daily fixed cost 573. After a user enters the pertinent information for a particular helicopter, the user may click add widget 574 so as to register the new helicopter with system 100. Helicopter list 575 can display a listing of all helicopters that are registered with system 100. Helicopter list 575 may include, for every helicopter listed therein, the corresponding pertinent details of the helicopter 576, as well as current helicopter status 577, edit widget 578 and delete widget 579. A user may select edit widget 578 to change information for any desired helicopter via setup portion 565. A user may also select add new helicopter widget 580 to display setup portion 565 so as to create a new helicopter and edit pertinent information for the new helicopter via setup portion 565.

FIG. 5f shows an exemplary well management interface 581 for a logistics management system 100. Well management interface 581 can include a well list 582. Well list 582 can display all wells registered with system 100, or may display a subset of registered wells based on parameters such as well type, platform, rig, and well status. Such parameters may be selected by a group of menus provided within well management interface 581. For every well displayed therein, well list 582 can include pertinent information, such as: well name 583, platform name 584, well type 585, rig name 586, well status 587, and well location 589. Well list 582 can also include view inventory widget 588, which the user may select to display a corresponding inventory for a particular well. For every well displayed therein, well list 582 can further include show/hide widget 590, edit widget 591 and delete widget 592. The user can thus show or hide a desired well on list 582, edit the pertinent information for that well, or delete the well from system 100.

Bulk Materials and Bulk Transfer Losses

System 100 may include the capability to manage bulk materials and to track bulk transfer losses. Typically, bulk materials are items that are shipped in bulk; that is, the bulk materials are not packaged into any type of container, barrel, or any other standalone receptacle, but rather shipped in separate, dedicated compartments aboard a vessel. For example, a vessel may have storage compartments that are intended to be used for the storage and transport of fuel, cement, potable water, base oil, and other materials.

It is also common that bulk material quantities are referred to, interchangeably, both in terms of weight/mass and in terms of volume. The particular units used to refer to a quantity of bulk material may depend simply on individual habit or on accepted practice within a particular organization; however, the use of diverse units for the same quantity of bulk material may result in confusion and introduce conversion errors into the calculations. Therefore, system 100 may be configured to accept and convert between commonly-used units of mass and volume based on a given density for a particular bulk material. Users may thus use any desired units of volume or mass when entering, viewing or editing quantities of a bulk material. An exemplary list of volume units used by default in system 100 may include liter, cubic meter, barrel, sack, gallon, and cubic foot. An exemplary list of weight/mass units used by default in system 100 may include long ton, metric ton, short ton, kilogram, and pound. Other units of measurement may be added to system 100 as desired by users having super-user privileges.

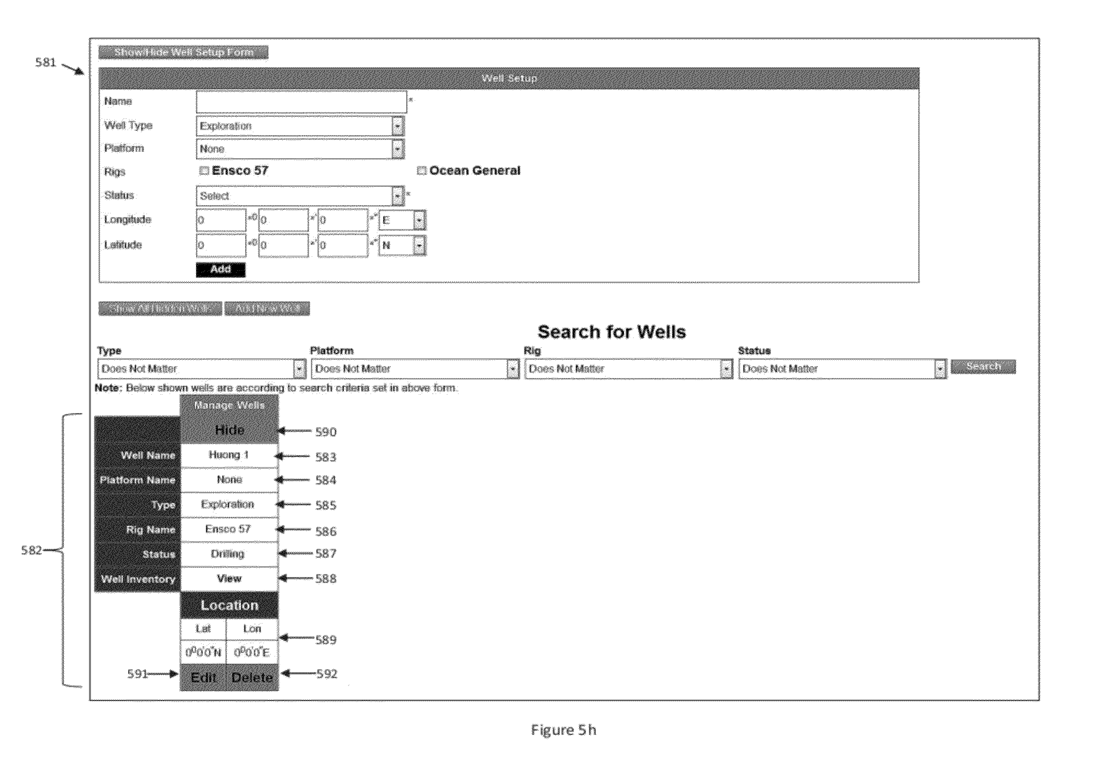

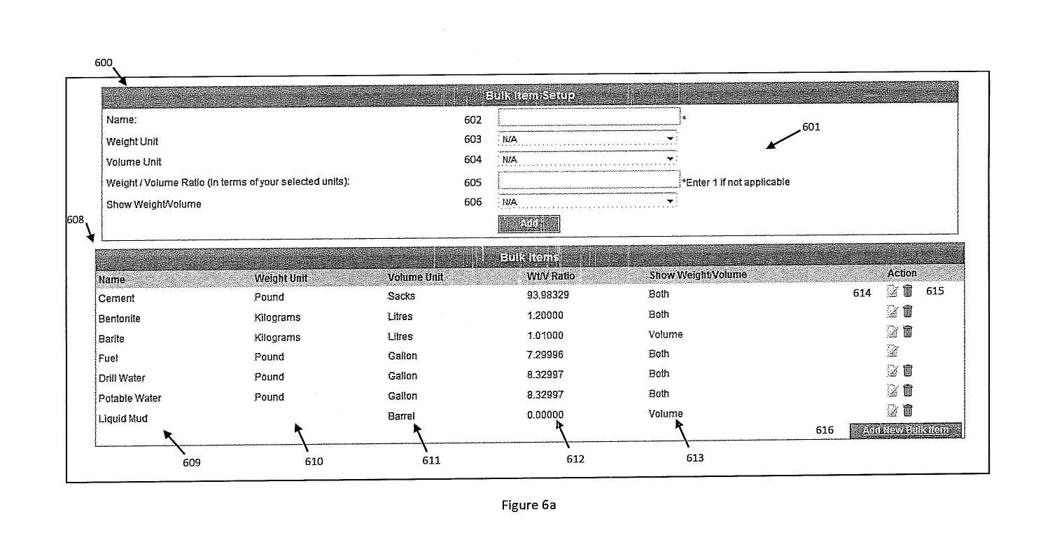

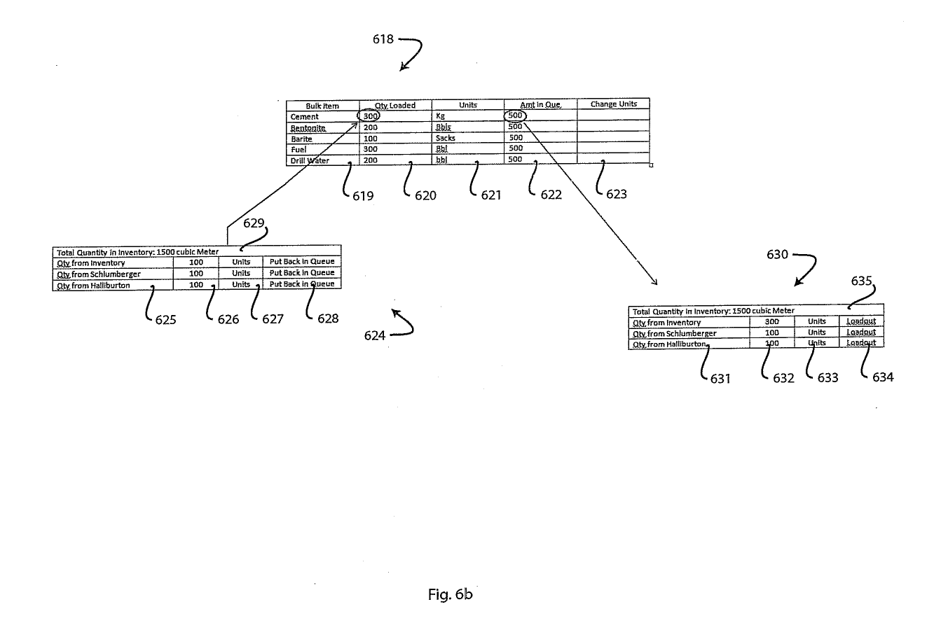

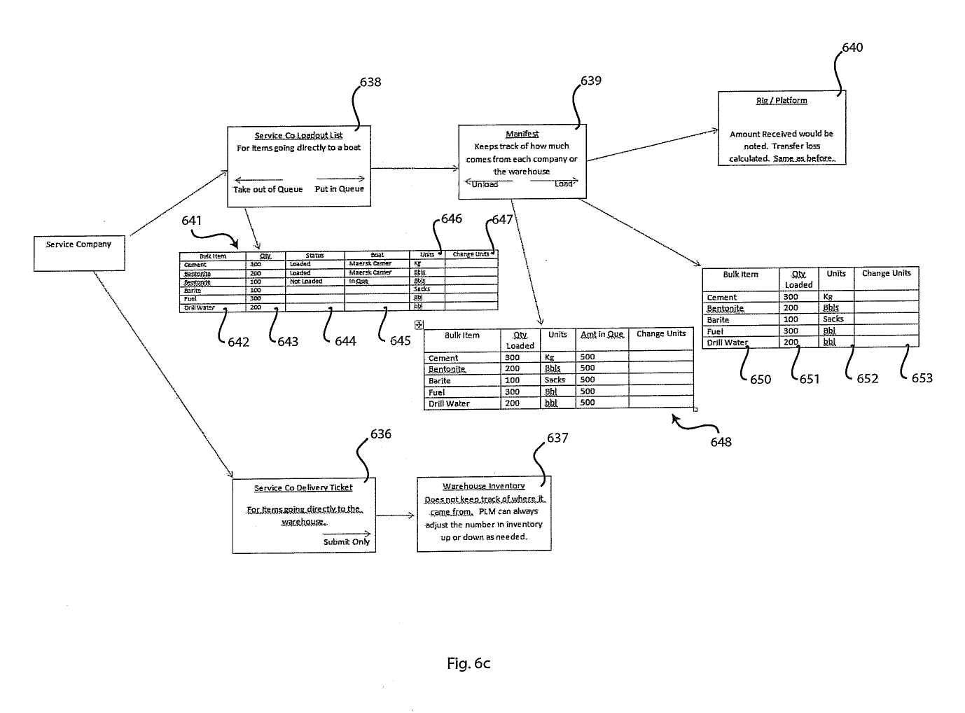

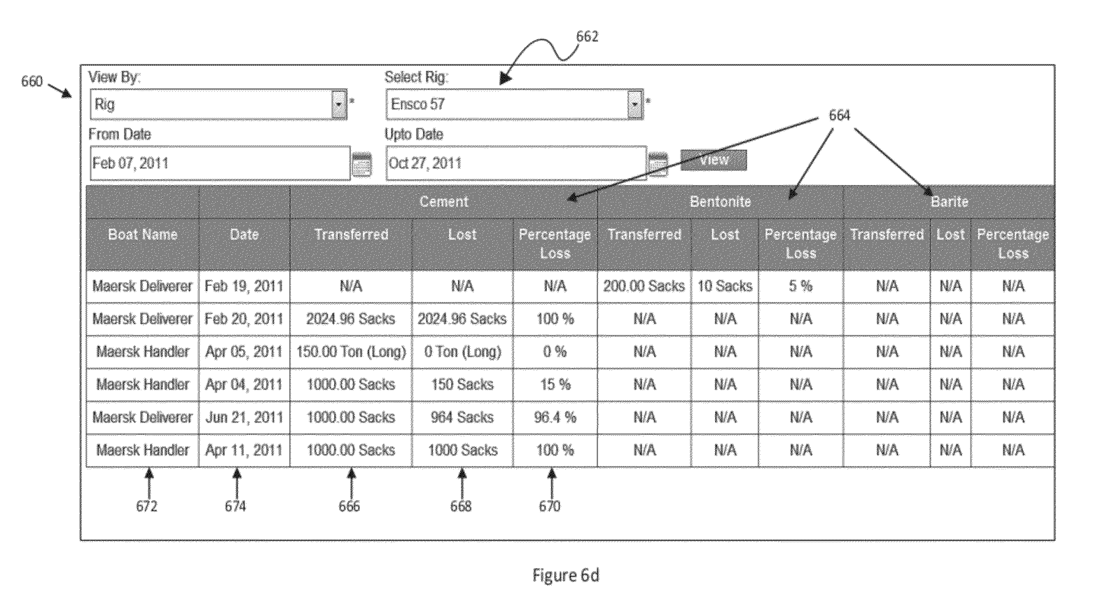

FIG. 6a shows an exemplary bulk materials management interface 600. Bulk materials management interface 600 may be accessed by users having super-user privileges. Bulk materials management interface 600 may include a bulk item setup portion 601 and a bulk item list 608. Bulk item setup portion 601 may allow for registration of new bulk items with system 100 and for specifying the physical characteristics thereof, or for editing the characteristics of bulk items that are registered with system 100. To that end, bulk item setup portion 601 may include therein a name field 602, a weight unit menu 603, a volume unit menu 604, a weight-to-volume ratio (i.e. density) field 605, and a show weight/volume ratio widget 606.

Bulk item list 608 may display all bulk materials that have been registered with system 100 as well as the corresponding characteristics thereof. For each bulk item registered with system 100, displayed in bulk item list 608 may be bulk item name 609, weight unit 610, volume unit 611, weight-to-volume ratio (density) 612, show weight/volume ratio (units) 613, edit widget 614 and delete widget 615. Bulk item list 608 may also include an add new item widget 616. When a bulk item is added this item may be seen on all manifests and inventory lists.

To input a new bulk item, a user having the required permissions may click add item widget 616, and then enter the name of the bulk item into name field 602, select a desired mass/weight unit using menu 603, and select a desired volume unit using menu 604. Subsequently, the user can enter a known density value into weight-to-volume ratio field 605. The user may then select, using show ratio widget 606, whether system 100 should accept and display quantities of the bulk item in terms of weight, volume, or both. Subsequently, the user can press add widget 607 to register the desired bulk material and its corresponding characteristics with system 100. To edit an existing bulk item, a user may click the edit widget 614 corresponding to the desired bulk item. At that point, the bulk item characteristics will be displayed in setup portion 601, whereupon the user may edit the characteristics, substantially as described above.

During the transfer of bulk items, there is a significant chance that some percentage of the bulk items will be lost to the environment. Additionally, some percentage of a bulk item is likely to remain in the storage compartment of a vessel after most of the bulk item is removed therefrom. Thus, the quantity of a bulk item that is received from a vessel is likely to be lower than the quantity that is shipped out in that vessel. The resulting difference is commonly known as a “transfer loss.” Thus, System 100 may include the capability to track both outgoing and incoming quantities of bulk items and to calculate and track transfer losses of bulk items.

As shown in FIG. 6b, system 100 may include an interface for managing and tracking bulk items. A working loadout manifest may include a bulk materials form 618. Bulk materials form 618 may display the bulk items and the quantities thereof that are present on the loadout manifest, as well as the quantities thereof that are in queue to be loaded on other vessels. Bulk materials form 618 may include bulk item name 619, quantity loaded 620, units 621, amount in queue 622 and a change units widget 623. Corresponding data for each bulk item present on the manifest may be listed in the appropriate fields of bulk item materials form 618.

If a user selects a quantity loaded field 620 for a particular bulk item, system 100 can display unload list 624 for that particular bulk item. Typically, when a vessel has a quantity of a bulk item loaded out, that quantity may be constituted from smaller quantities of the bulk item, which are provided from various sources. Such sources may include inventory, or various service companies or other entities. Thus, unload list 624 may display the sources of and corresponding quantities of a particular bulk item, as well as the total quantity of that particular item in inventory. For each bulk item, unload list 624 may include fields showing source name 625, quantity 626, units 627, and return to queue widget 628, as well as total quantity in inventory 629. If a user desires to take a quantity of a bulk item off the loadout manifest, they may select return to queue widget 628, and the corresponding quantity of the bulk item will be returned to the bulk item queue.

If a user selects an amount in queue field 622 for a particular bulk item, system 100 can display queue list 630 for that particular bulk item. Queue list 630 can display the quantities of bulk materials that are not loaded onto any vessel, but are queued for loading on to a vessel in the future. Each queued bulk item quantities may be constituted from smaller quantities of the bulk item, which can be provided from various sources, such as inventory, various service companies, or other entities. Thus, queue list 630 may display the sources of and corresponding quantities of a particular bulk item, as well as the total quantity of that particular item in inventory. For each bulk item, queue list 630 may include fields showing source name 631, quantity 632, units 633, and loadout widget 634, as well as total quantity in inventory 635. If a user desires to place a quantity of a bulk item onto the loadout manifest, they may select loadout widget 634, and the corresponding quantity of the bulk item will be taken out of the bulk item queue and placed on the loadout manifest.

As shown in FIG. 6c, system 100 may provide a process for tracking bulk items delivered from service companies. For bulk items going from a service company to a warehouse, the user may use a service company delivery ticket 636. The bulk item can then be placed into warehouse inventory 637. The sources of bulk items in warehouse inventory 637 are not tracked; however the quantity of the bulk items may be adjusted by the port logistics manager as desired. In the case of items going from a service company to a vessel, the items may be placed on the service company loadout list 638. Subsequently, the items can be put in queue to be placed on a manifest 639. The items can then be loaded on a vessel, and delivered to a rig or platform 640. System 100 can track the bulk items at each step of the process. To track the items on the service company loadout list, a loadout list form 641 may be provided. For each bulk item on the service company loadout list, loadout list form 641 may display bulk item name 642, quantity 643, loading status 644, boat name 645, units 646, and change units widget 647. Corresponding data for each bulk item present on the manifest may be listed in the appropriate fields of loadout list form 641. To track the items on the manifest, a bulk materials form 648 may be provided. The bulk materials form may be substantially the same as the bulk materials form 641, described above. To track the items that have been loaded onto a departing vessel, a departed manifest form 649 may be provided. For each bulk item on the departing vessel, departed manifest form 649 may display bulk item name 650, quantity 651, units 652, and change units widget 653. Corresponding data for each bulk item present on the departing vessel may be listed in the appropriate fields of bulk item materials form 648.

System 100 can calculate and display transfer losses of bulk items. The total quantity of a bulk item loaded on a vessel can be entered into a final outbound manifest. For each bulk item, the quantity shipped from the port and the quantity received at the rig or platform can be entered into and tracked by system 100. The quantity shipped out may be submitted by the port logistics manager, and the quantity received may be submitted by the rig logistics manager. System 100 can calculate the quantity and percentage of bulk items lost for each bulk item.

As shown in FIG. 6d, system 100 can provide a bulk transfer loss report 660 for any desired rig, platform, vessel, or bulk material and for a desired date range. These parameters may be controlled by a group of widgets 662 provided within bulk transfer loss report 660. For every bulk item registered with system 100, bulk transfer loss report 660 can display bulk item name 664, quantity transferred 666, quantity lost 668, and percentage loss 670. These data may be sorted by boat name 672, date 674, rig name, or any other desired criteria.

Boat Manifests

System 100 can include the capability to create and manage boat manifests. Boat manifests can be used to facilitate tracking items, for example, bulk items, supplies, or equipment, that are being moved from a first location to a second location. System 100 may provide a simplified method of moving and tracking items and selecting vessels on which the items can be loaded.

Every vessel may have its own, separate boat manifest. If a user desires to send a particular item to a desired location, the user may select the item, for example, from a warehouse inventory list. The user may then loadout the item, whereupon system 100 can change the status of item as “in queue” for shipment to the desired location. Subsequently, System 100 can show all items that are in queue to a particular location in a separate “in queue” section of the boat manifests of all vessels that are traveling to that particular location. A user may then choose a desired vessel for transporting the item to the desired location. This may be accomplished by viewing the desired vessel's boat manifest, selecting the desired items from the “in queue” section, and loading the desired items onto the vessel. The above-described method may be applied to personnel traveling to a desired location in substantially the same manner.

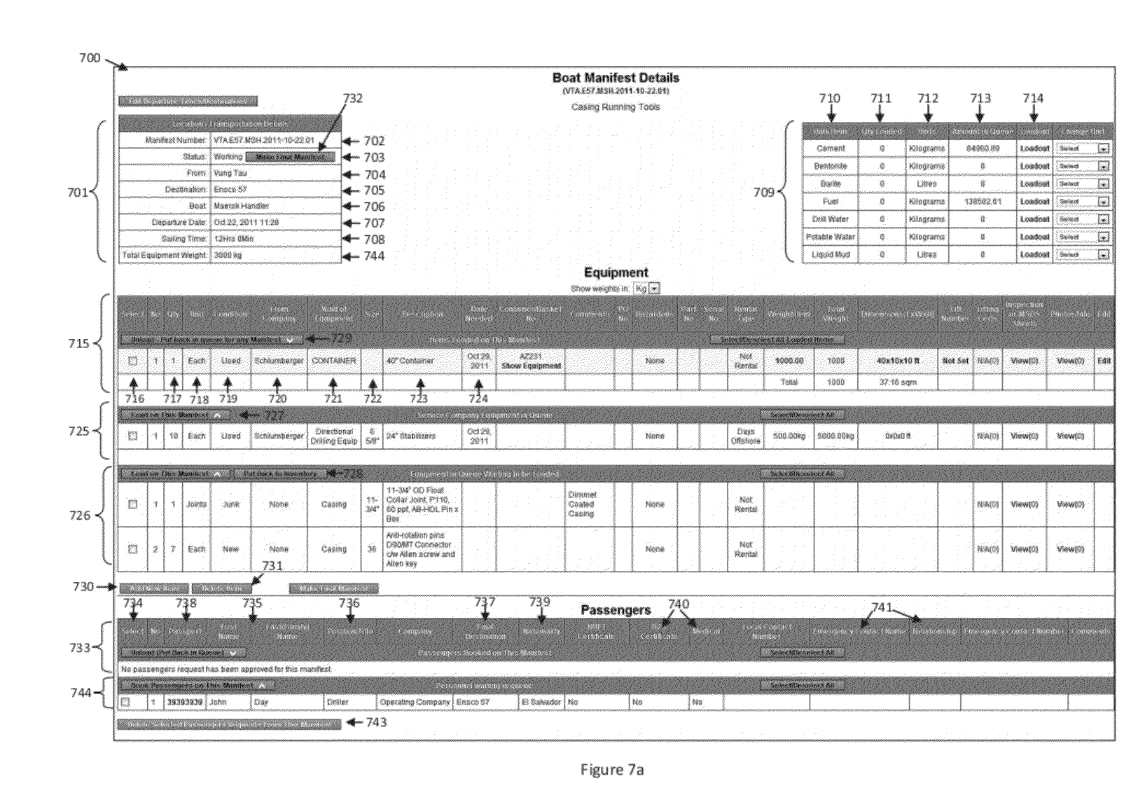

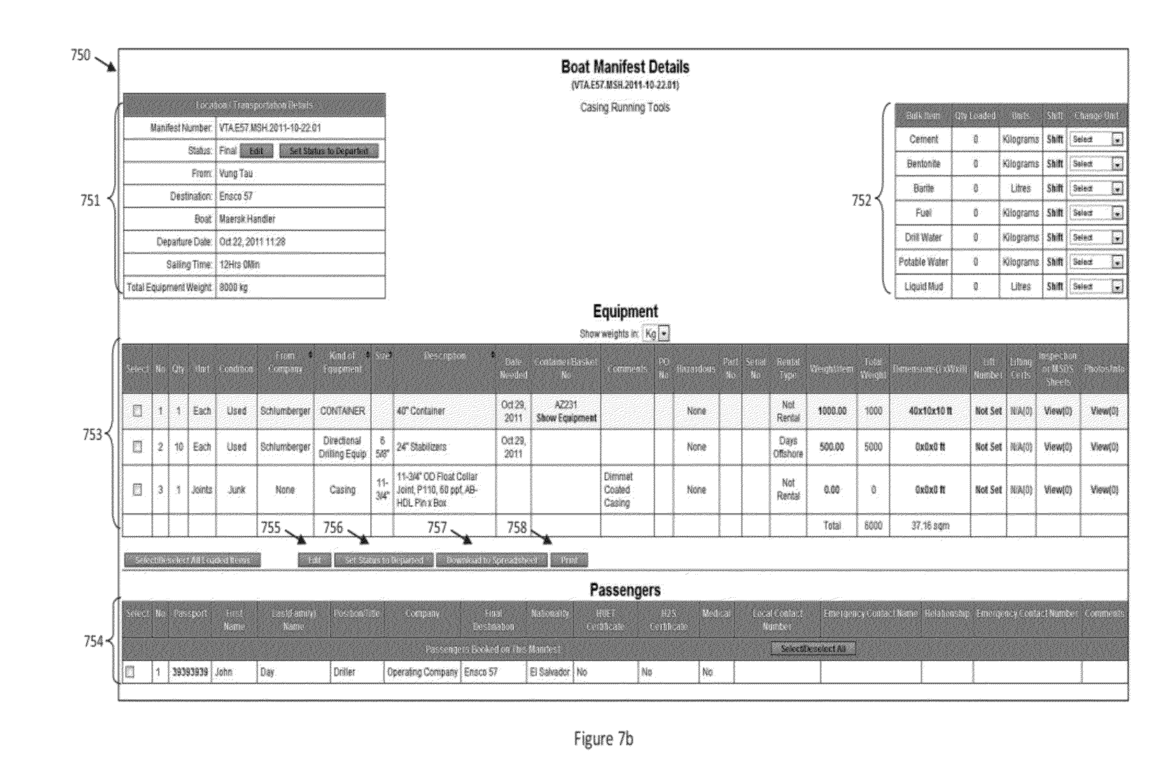

An exemplary boat manifest interface is shown in FIGS. 7a-7b. FIG. 7a shows an exemplary interface for a “working” manifest 700, that is, a boat manifest that has not been finalized. Working manifest interface 700 may include location and transportation details list 701, bulk materials list 709, on-board materials list 715, service company equipment in queue list 725, and company equipment in queue list 726. Location and transportation details list 701 may display information pertinent to the vessel for which the particular boat manifest is being viewed. Such information may include manifest number 702, manifest status 703, departure point 704, destination 705, boat name 706, departure date 707, sailing time 708, total calculated equipment weight 744, and any other pertinent information. Bulk materials list 709 may include, for each bulk item in queue, bulk item name 710, quantity loaded 711, units 712, quantity of bulk item in queue 713, and loadout widget 714. The user may select loadout widget 714 for any desired bulk item to place a desired quantity of that bulk item onto the boat manifest. When placed in queue, the particular bulk item can be retrieved from the company warehouse inventory. On-board materials list 715 may display all items that have been placed on the boat manifest of the particular vessel. For each item, on-board materials list 715 may display details such as: select widget 716, item quantity 717, units 718, item condition 719, equipment provider company name 720, item type 721, item size 722, item description 723, date item is needed 724, and any other desired information that is pertinent to the item, such as, for example, the container in which the equipment is located, comments, part identification numbers, certificates and material safety data sheets (uploaded to the system), photos, and so forth, as shown in FIG. 7a. The above-described details may likewise be displayed on service company equipment in-queue list 725 and company in-queue list 726. Additionally, working manifest interface 700 may include action widgets such as: load on manifest 727, return to inventory 728, return to queue 729, add item 730, delete item 731, and finalize manifest 732. Thus, a user may select an item using the item's corresponding select widget 716, and then execute an action using one of the action widgets. Thus, for example, in order to transfer a desired item from the queue to the boat “loaded” part of the manifest, a user can select an item in queue list 726, then select load on manifest widget 727. A similar process can be followed to remove an item from the boat manifest, or to execute any other action via the action widgets.

Working manifest interface 700 may further include passenger list 733 and passenger in queue list 744. For each passenger, passenger list 733 and the passenger in queue list may display details such as select widget 734, passenger name 735, employment information 736, destination 737, passport number 738, nationality 739, uploaded certificates 740, contact information 741, and any other identifying and/or contact information that is pertinent to the passenger, as shown in FIG. 7a. Additionally, working manifest interface 700 may include action widgets such as add passenger (not shown), remove passenger 743 and book passenger on boat (not shown). The method of utilizing the action widgets can be substantially similar to that described above. Once all desired items and passengers have been placed on the boat manifest for the desired vessel, the user may finalize the boat manifest using finalize manifest widget 732.

FIG. 7b shows an exemplary interface for a final manifest 750. A final manifest is created once a working manifest is finalized, and, therefore, no additional items can be added via the final manifest interface. Final manifest interface 750 may include location and transportation details list 751, bulk materials list 752, on-board materials list 753, and passenger list 754. Lists 752, 753 may display the items that have been loaded onto the vessel. Lists 751, 752, 753, 754 may include details that are substantially similar to the details included in lists 701, 709, 715, 733, described above. Additionally, final manifest interface may include action widgets such as: edit 755, set status to departed 756, download to spreadsheet 757, and print 758. Edit widget 755 can allow the user to return the status of the boat manifest of the particular vessel to “working” so that items and passengers can be added or removed. After the particular vessel has left its point of departure, the user can select set status to departed widget 756 so as to update the status of the particular vessel in system 100. When the status is set to departed, the vessel can leave the location en route to its next destination. Upon arrival at the next destination, the manifest status will be changed again to “landed-received” by users of system 100 at the next location, via internet access to system 100. When the status is changed to “landed-received,” the items in the manifest can be selected 716 and moved to the next destination warehouse inventory with a move-to-inventory widget (not shown). This feature can allow the user to not be required to re-enter the pertinent information into the local inventory list.

Materials Tracking

System 100 may include the capability to track and manage parts and materials that may be used in various operations, stored at various locations, or transferred between locations. To that end, system 100 may include capabilities to track and manage warehouse inventories, floating stock, and part movements. Warehouse inventories may facilitate tracking and managing parts and materials that are in storage at onshore and offshore locations. Floating stock tracking may facilitate tracking and managing parts and materials that are present on vessels. The term floating stock is typically used to refer to parts and materials that are not necessarily en route to a location, but rather have been left on a vessel that is in the field, for delivery at a later date.

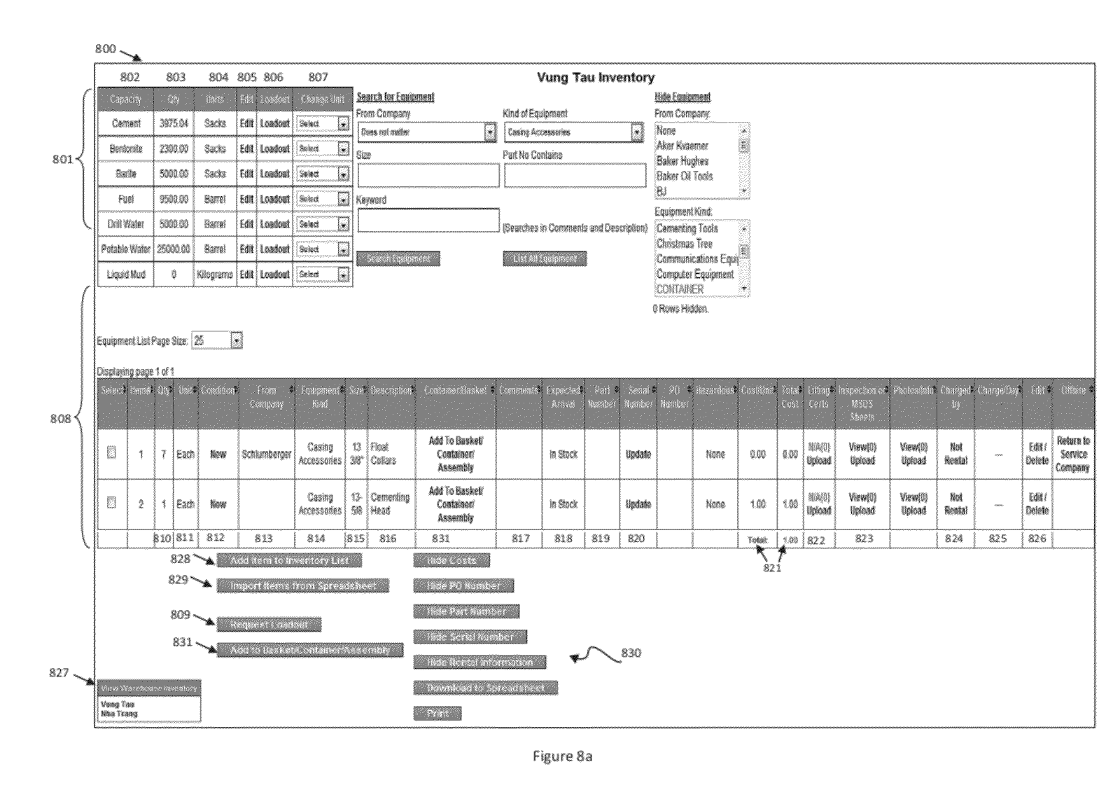

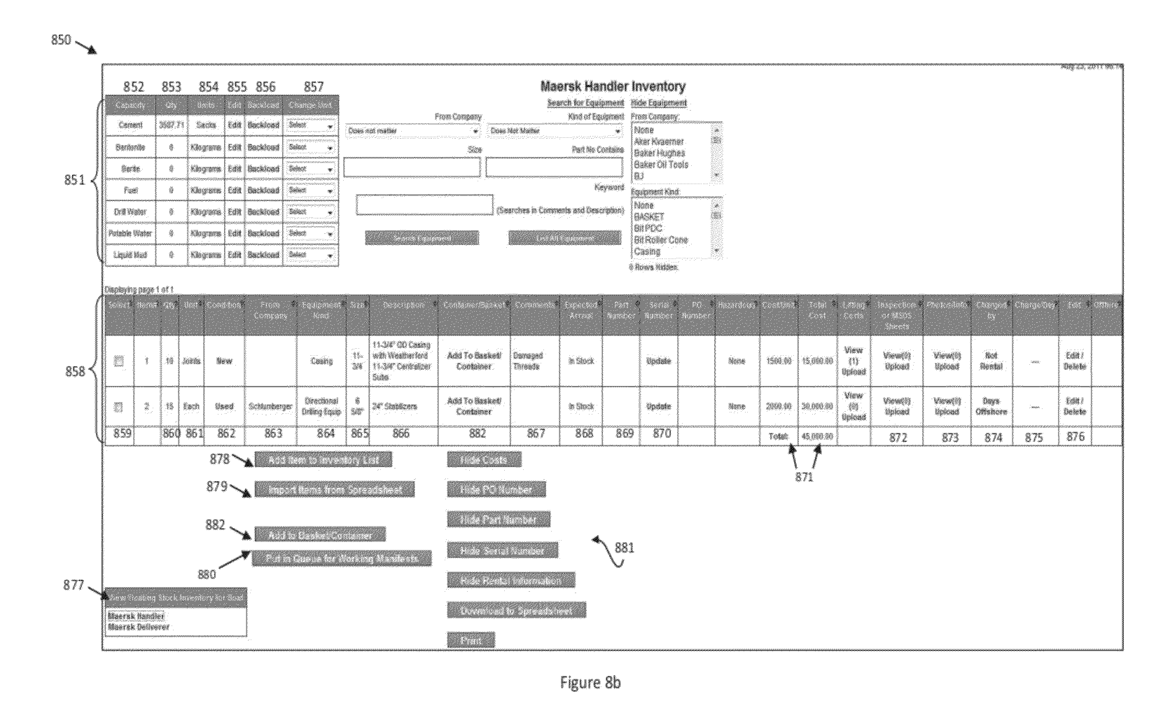

FIG. 8a shows an exemplary warehouse inventory interface 800 of logistics management system 100. The warehouse inventory interfaces for onshore and onshore locations may be similar or substantially the same. Warehouse inventory interface 800 may include bulk materials list 801, item list 808 and list of other warehouses 827. Bulk materials list 801 can display the bulk materials that are being stored at the location for which the warehouse inventory list is being viewed. Bulk materials list 801 may include, for each bulk material listed thereon, bulk item name 802, quantity 803, unit 804, edit widget 805, loadout widget 806, and change unit menu 807. Item list 808 can display the items that are being stored at the location for which the warehouse inventory list is being viewed. Item list 808 may include, for each item listed thereon, loadout widget 809 (for moving any item to a manifest), quantity 810, unit 811, item condition 812, company 813, equipment type 814, item size 815, equipment description 816, comments 817, expected arrival date 818, part number 819, serial number 820, cost 821, upload certificates and MSDS sheets widget 822, upload photos widget 823, charge type (e.g. “rental” or “not rental”) 824, charge per day 825, and edit/delete widget 826. List of warehouses 827 may display the onshore or offshore warehouses registered with system 100. A user may select a warehouse from the list of warehouses in order to view the corresponding warehouse inventory list and bulk item list for the particular warehouse. Additionally, warehouse inventory interface may include widgets for adding items to inventory 828, importing from spreadsheet 829, add items to basket/container 831, and display control widgets 830.

FIG. 8b shows an exemplary floating stock interface 850 of logistics management system 100. Floating stock interface 850 may include bulk materials list 851, item list 858 and list of vessels 877. Bulk materials list 851 can display the bulk materials that are being held on the particular vessel for which the floating stock interface is being viewed. Bulk materials list 851 may include, for each bulk material listed thereon, bulk item name 852, quantity 853, unit 854, edit widget 855, backload widget 856, and change unit menu 857. Item list 858 can display the items that are being held on the particular vessel for which the floating stock interface is being viewed. Item list 858 may include, for each item listed thereon, select widget 859, quantity 860, unit 861, item condition 862, company 863, equipment type 864, item size 865, equipment description 866, add to basket/container widget 882, comments 867, expected arrival date 868, part number 869, update serial number widget 870, cost 871, upload certificates widget 872, upload photos widget 873, charging type 874, charge per day 875, and edit/delete widget 876. List of vessels 877 may display the vessels that are registered with system 100. A user may select a vessel from the list of vessels in order to view the corresponding floating stock list and bulk item list for the particular vessel. Additionally, floating stock interface may include widgets for adding items to inventory 878, importing from spreadsheet 879, queuing items on working manifests 880, and display control widgets 881.

Loadout Lists

System 100 can include the capability for creating and managing loadout lists. If a service company desires to send certain items to a destination, it can use system 100 to create a loadout list, listing and describing the items to be sent to the destination by boat, truck or helicopter. The service company can then define the point of departure and the destination for the loadout list. System 100 can then place the items that are in the loadout list onto all of the “in queue” sections of all manifests for vessels having the same points of departure and destinations as those defined for a particular loadout list. These items can be placed in queue when the status of the loadout list is changed to “final status.” A port logistics coordinator or helicopter coordinator can then loadout the queued items onto the manifest for a desired vessel. At that point the loaded out items can be taken off the queue. When these items are loaded on a vessel then the vessel name and manifest number can be displaced on the service company loadout list.

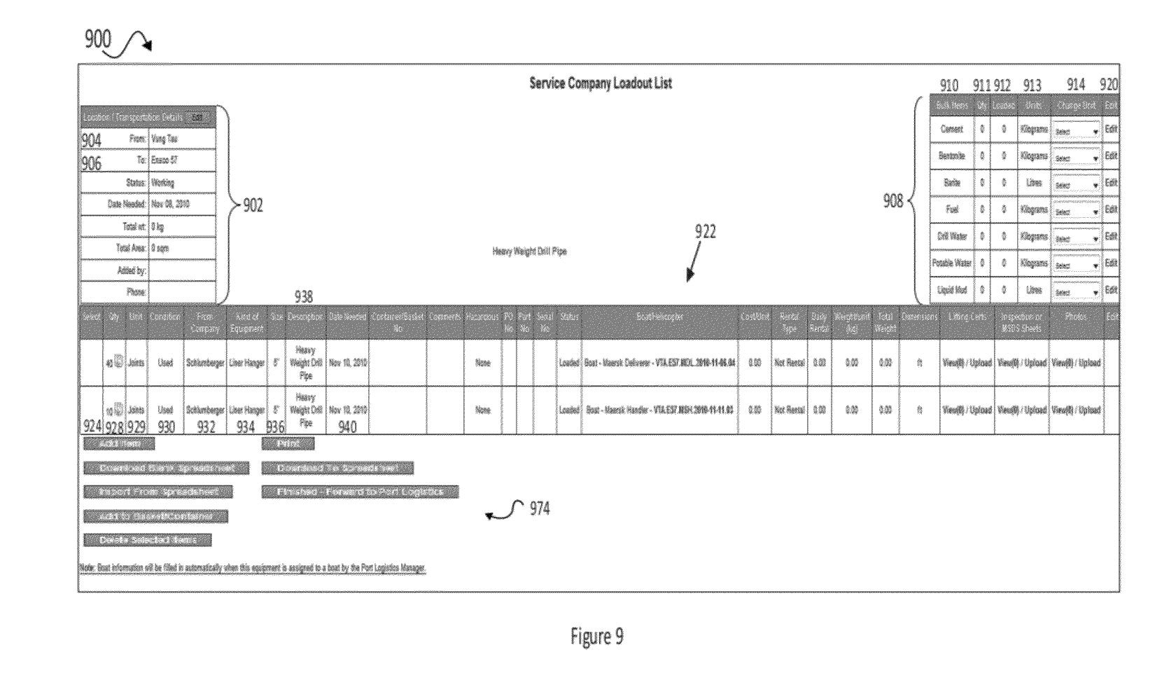

FIG. 9 shows an exemplary interface for a loadout list 900. Loadout list interface 900 may include location details list 904, bulk materials list 908, and item list 922. Location details list 904 may display information pertinent to the origin and destination of the particular loadout list. Such information may include departure point 904, destination 906, and any other pertinent information. Bulk materials list 908 may include, for each bulk item on the loadout list, bulk item name 910, quantity 911, quantity loaded 912, units 913, change unit widget 914, and edit widget 920. The user may select edit widget 920 for any desired bulk item to change the quantity of the bulk item on the loadout list. Item list 922 may display all items that have been placed on the particular loadout list. For each item, on-board materials list may display details such as: select widget 924, item quantity 928, units 929, item condition 930, company name 932, item type 934, item size 936, item description 938, date item is needed 940, and any other desired information that is pertinent to the item, as shown in FIG. 9. Additionally, loadout list interface 900 may include action widgets such as: add item to list 974, delete selected items 976, print 977, download to spreadsheet 979, and finalize loadout list 980. Thus, a user may select an item using the item's corresponding select widget 924, and then execute an action using one of the action widgets. Thus, for example, in order to remove a desired item from the loadout list, a user can select an item in item list 922, then select delete selected items widget 976. Once the loadout list is complete, the user can select finalize widget 980 so as to finalize the list and forward it to the port logistics manager. System 100 can then place the items on the particular loadout list onto the queue lists of all vessels traveling between the origin and destination locations of the particular loadout list.

Service Company Manifests

System 100 can include the capability for creating and managing service company manifests. System 100 can generate service company manifests showing all items that have been loaded onto a vessel for shipment to a destination. Once a service company creates a loadout list, system 100 can automatically generate a service company manifest, which can show which items are in queue or in transit, and onto which vessel those items are loaded. Users may then check the service company manifest to determine the location and status of particular items, and the service company manifest is automatically updated when the status of any item changes. Thus, it is not necessary for a user to manually manage a service company manifest when a particular item is loaded onto a vessel, offloaded from a vessel, or transferred between vessels en route to the destination.

Rental Equipment

System 100 can include the capability for managing rental equipment and facilitating billing for the use of rental equipment. A user may specify a particular piece of equipment in system 100 as a rental tool, and indicate a periodic rental rate therefor. The periodic rental rate may be hourly, daily, weekly, monthly, or any other desired period. The user may further specify upon which event billing for the rental tool is commenced and terminated. For example, billing for a rental tool may commence when the tool is loaded onto a vessel, delivered to the destination, or at any other specified point. System 100 can track rental tools via loadout lists and vessel manifests, substantially similar to tracking other equipment and bulk materials, as described above. As a particular rental tool is added to and removed from loadout lists, vessel manifests, and so forth, system 100 may record the times and dates therefor. For example, system 100 can record when a particular rental tool was removed from a warehouse, loaded onto a vessel, delivered to a destination, and placed into operation. System 100 can then use such recorded dates and times, in conjunction with the periodic rental rates for the tool and the events upon which billing is commenced or terminated, to calculate the total amount that is billed for the rental of the particular rental tool.

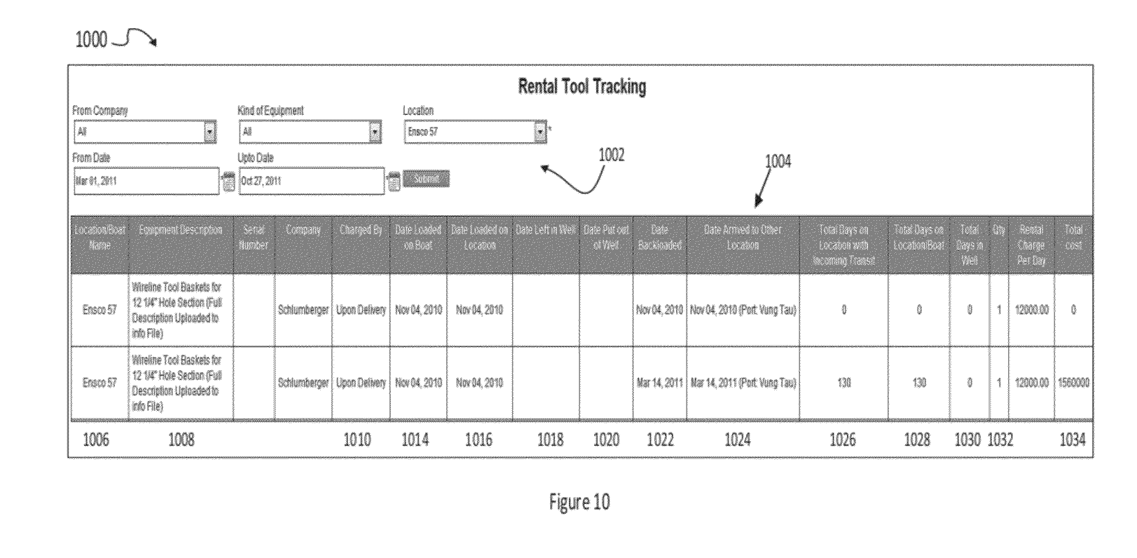

FIG. 10 shows an exemplary interface for rental tool tracking 1000. System 100 can provide rental tool tracking information for any desired company, equipment type, or location, and for a desired date range. These parameters may be controlled by a group of widgets 1002 provided within rental tool tracking interface 1000. Rental tool tracking interface 1000 may further include equipment details list 1004. Equipment details list 1004 may include, for each rental tool listed therein, location 1006, equipment description 1008, charged by 1010, rental rate 1012, load on vessel date 1014, load on location date 1016, left in well date 1018, removed from well date 1020, backloaded date 1022 date arrived at next location 1024, total days on location 1026, total days offshore 1028, days in well 1030, quantity 1032 and total cost 1034. For each item, system 100 may calculate total cost based on the dates, durations and rental rates listed in equipment details list 1004.

Operations Look-Ahead Timelines

System 100 can include the capability to create and track look-ahead timelines for various operations aboard a rig or at another location. The look-ahead timelines may be used to obtain a listing of future expected operations and their expected durations. Additionally, system 100 may present the look-ahead timelines in a calendar format or a seven-day operations forecast format, wherein the future expected operations can be separately listed for each upcoming day. Users, such as, for example, drilling superintendents, drilling managers, and rig supervisors can view and edit the events in the look-ahead timelines via system 100. Additionally, events such as helicopter flights, boat arrivals and departures, and so forth, that have been already entered into system 100, can be automatically displayed on the seven-day operations forecast for the corresponding locations. If a user selects such an event, system 100 may present the user with a vessel manifest or other pertinent information for such an event. For example, if a particular vessel is listed in the seven-day operations forecast as arriving at a particular rig, then selecting that event can display the corresponding boat manifest for that vessel.

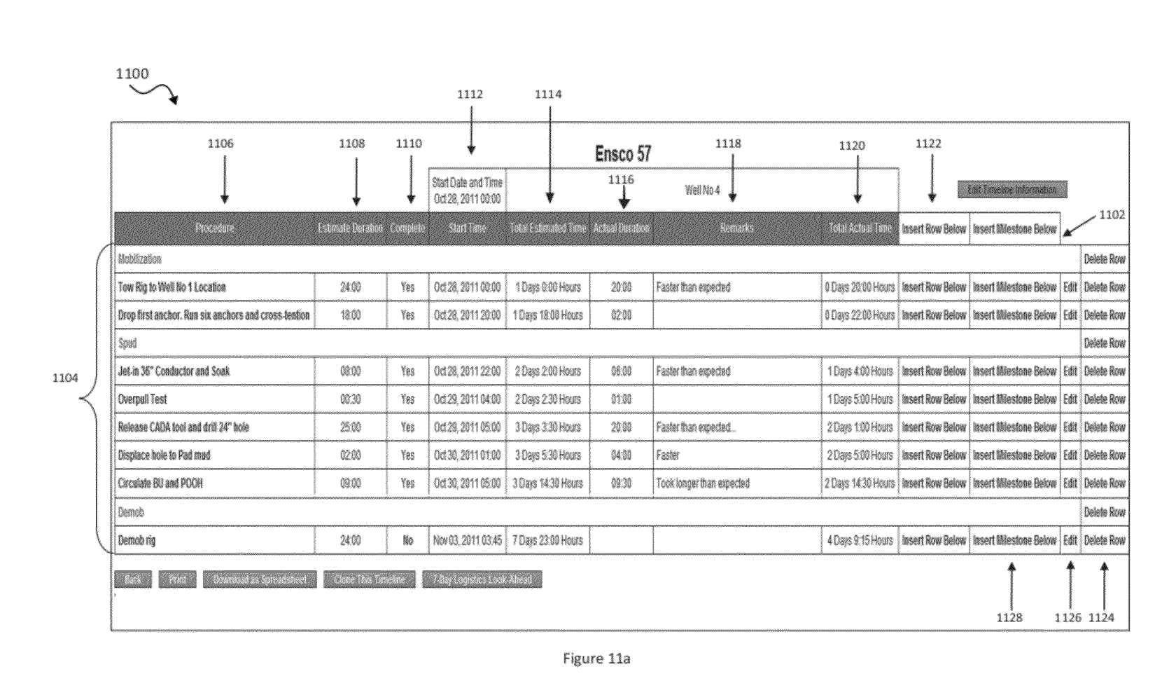

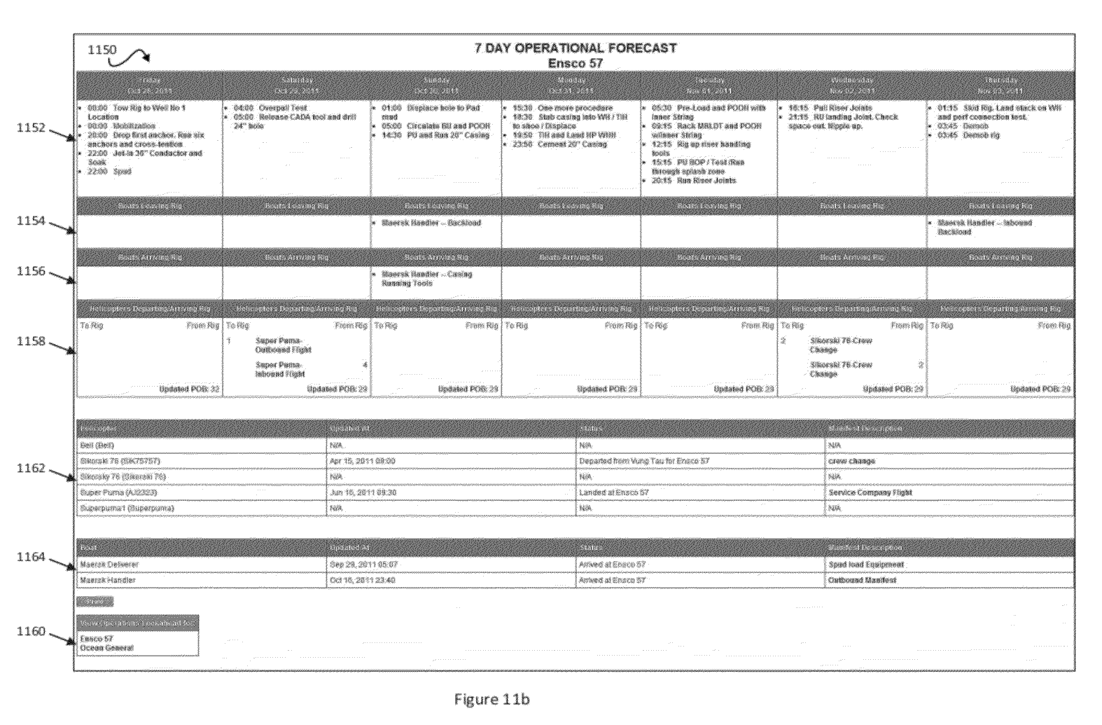

FIG. 11a shows an exemplary interface for a look-ahead sheet 1100. Look-ahead sheet interface may include operation entry fields 1104, start times/dates 1112, and edit widgets 1126. Operation entry field 1102 may allow the user to add a new operation or edit existing operations for the particular location that is being viewed. Operations list 1104 may include, for each operation listed therein, operation name 1106, estimated duration 1108, completion status 1110, start time 1112, total estimated time 1114, actual duration 1116, remarks 1118, total actual time 1120, insert row below widget 1122, insert milestone widget 1128, and delete row widget 1124. Thus, a user may enter expected operations and their expected durations and start times into operations list 1104 using the provided fields and widgets. Upon completion of an operation, a user may change the status of the operation to “completed”, and may enter the actual time taken by the operation or the time that then operation was completed. Alternatively, upon completion of the operation, a user may change the status of the operation to “completed” and system 100 can automatically calculate the actual time taken by the operation based on the present time and date. Thus, system 100 can provide a look-ahead operations timeline for a particular location, as well as a log of all completed operations at the particular location. System 100 can also allow a user to clone an existing timeline to another well, if desired 1128.

FIG. 11b shows an exemplary interface for a seven-day operational forecast 1150. Seven-day operational forecast 1150 may display expected operations for the present day and the next six days thereafter. The user may also edit the settings for calendar interface 1150 so as to display any desired number of days. For each day, calendar interface 1150 may display information regarding expected operations 1152, boats leaving location 1154, boats arriving on location 1156, and helicopters arriving or leaving location 1158. The user may select a particular item in calendar interface 1150 to display further information regarding that item. For example, selecting a vessel manifest link may display the vessel manifest for the vessel on which the particular item is loaded. Similarly, selecting an operation may display the look-ahead sheet on which the particular operation is listed. Look-ahead calendar interface 1150 may further include a locations list 1160. Locations list 1160 may display the various locations that are registered with system 100 with links to the seven-day look ahead interfaces for those locations. Look ahead calendar interface 1150 may also include a helicopter status update list 1162, and a boat status update list 1164. For example, if a helicopter has departed a location, a departure status may be seen, and if a boat has arrived at a location, an arrived status may be seen. Lists 1162, 1164 can also show the boat and helicopter name, the time and date of the last status update, the current status of the boat or helicopter, and the manifest description for the boat or helicopter.

Callout Lists

System 100 may include the capability to manage callout lists. Callout lists can be used by users such as rig supervisors or platform supervisors to request that desired equipment be sent offshore to a particular location. Users may also request that the items be delivered by a desired date. The callout lists may be viewed by users such as port logistics managers, so as to provide such users with a list of items that need to be loaded out on vessels leaving the particular point of departure.

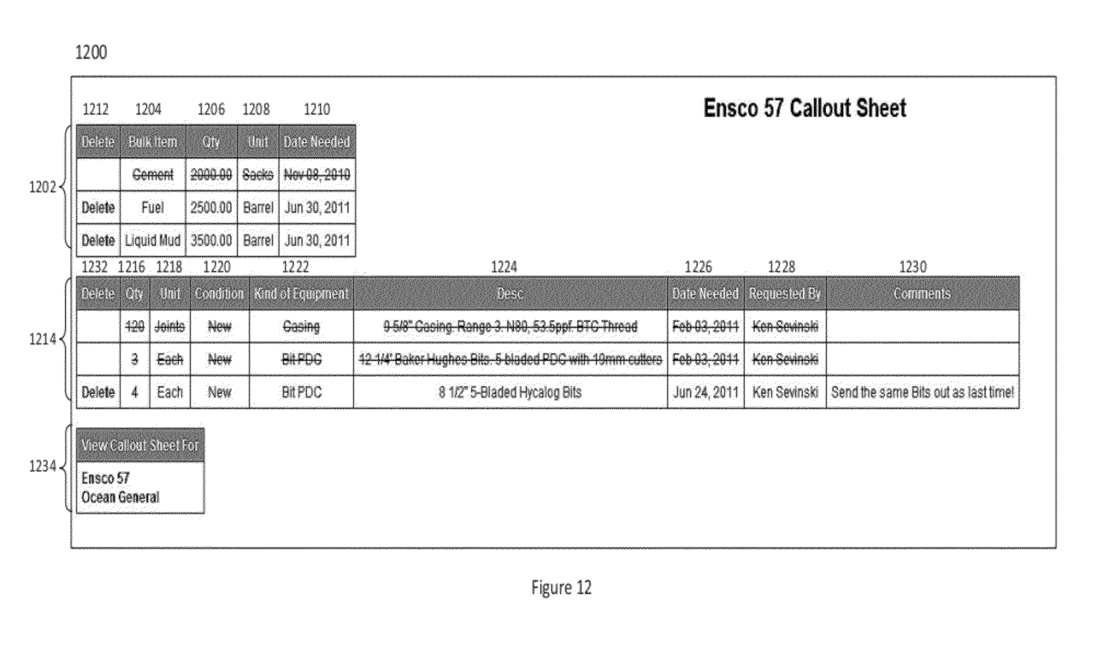

FIG. 12 shows an exemplary interface for a callout list 1200. Callout list interface may include bulk materials list 1202, item list 1214 and list of callout lists 1234. Bulk materials list 1202 can display the bulk materials that have been requested to be delivered to the location for which the callout list is being viewed. Bulk materials list 1202 may include, for each bulk material listed thereon, bulk item name 1204, quantity 1206, unit 1208, date needed 1210, and delete widget 1212. Item list 1214 can display the items that have been requested to be delivered to the location for which the callout list is being viewed. Item list 1214 may include, for each item listed thereon, information regarding quantity requested 1216, unit 1218, item condition 1220, equipment type 1222, equipment description 1224, date needed 1226, the requesting user 1228, comments regarding the item 1230, and delete widget 1232. In operation, a user at the location where equipment is needed, such as a rig or platform supervisor, can enter desired items onto the callout list. The user may not need to enter all pertinent information for each item onto the callout list. In such cases, system 100 may fill in the missing information, for example such as equipment description 1224, from other available sources, such as, for example, warehouse equipment lists or service company loadout lists. Subsequently, a user at the location where the equipment is present, for example such as a port logistics manager, can view the list of requested items and load out the items onto a vessel. Once the items are loaded out onto a vessel, the port logistics manager can use delete widget 1232 to mark the items as loaded. System 100 can then display the marked items using a strike-through font, indicating that the items are on board the vessel. Once the items have been delivered to the destination, the rig or platform supervisor can use delete widget 1232 to mark the items as delivered. At that point, the delivered items are removed from the callout list. To view another callout list, a user may select the desired list from list of callout lists 1234, and system 100 can display the contents thereof via callout list interface 1200.

Planning Files

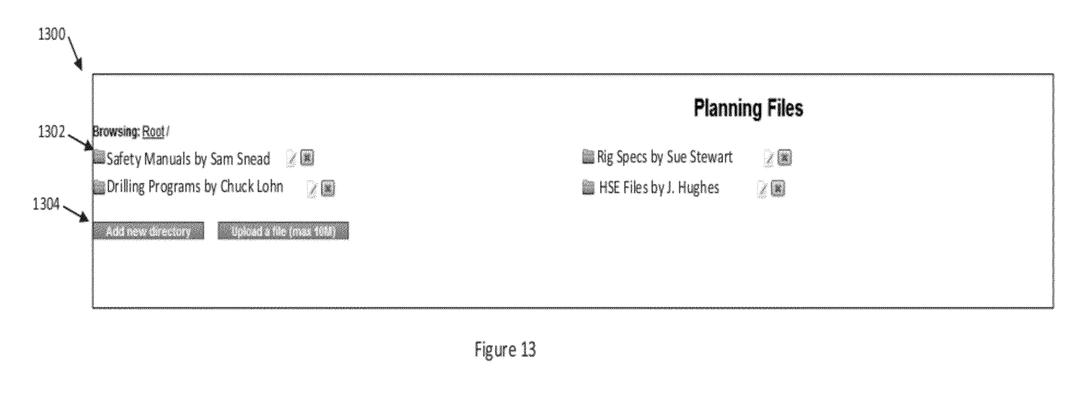

System 100 may include the capability to upload, store, view and edit documents related to planning and performing offshore operations. Such documents may be accessed via planning files interface 1300, as shown in FIG. 13. Planning files interface 1300 may include a file list 1302, an add directory widget 1304 and upload file widget 1306. File list may display all documents and directories in the particular directory that is being viewed. For each document or directory displayed, planning files interface 1300 may include the name of the user that uploaded the particular document or created the particular directory, as well as an edit widget 1308 and delete widget 1310. The planning files interface 1300 may be viewed from any location that is capable of accessing system 100.

Contact Lists

System 100 may include the capability to manage, edit and view contact lists for a particular location or operation. The contact lists can display personal and contact information for all personnel that are assigned to a particular location or operation. To display the personal and contact information for a user on a contact list, system 100 may access the personal and contact information for that particular user that was given when the particular user was entered into system 100. Users may also clone contact lists; that is, a list of contacts, or portion thereof, for a particular location or operation may be copied and used as a contact list for a different location or operation.

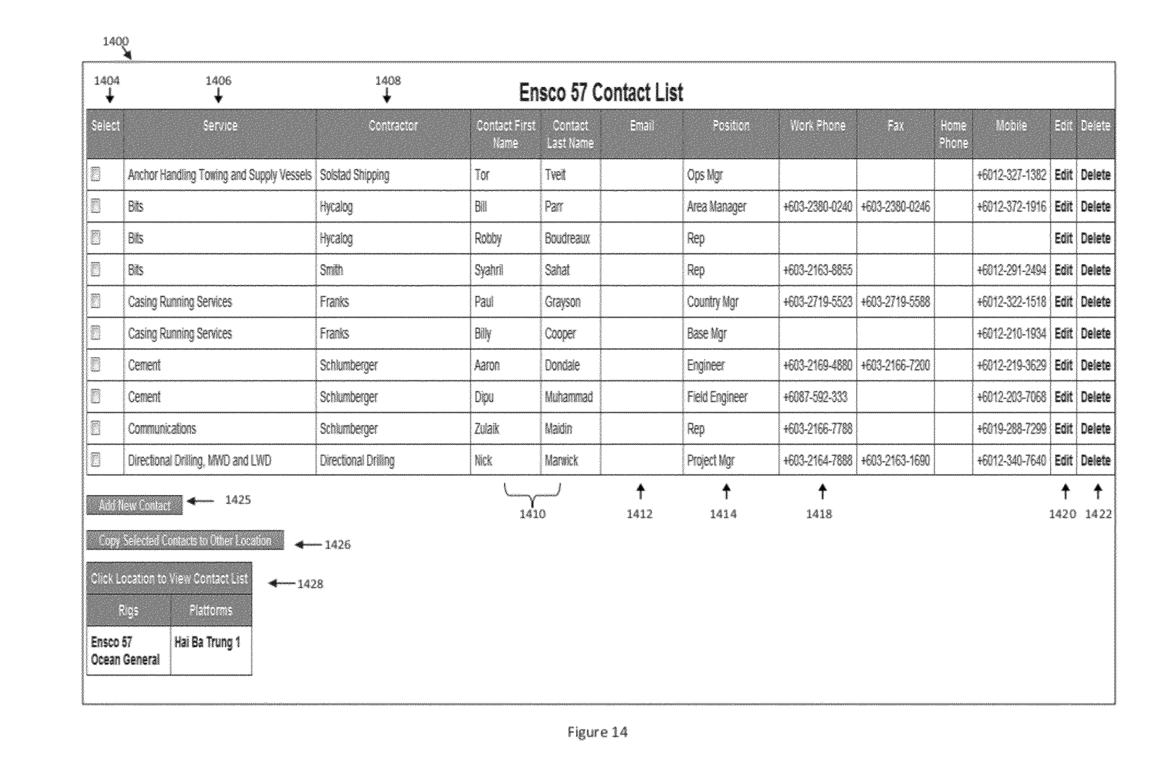

FIG. 14 shows an exemplary contact list interface 1400. Contact list interface may include personnel list 1402 and list of contact lists 1428. Personnel list may include, for each individual displayed thereon, select widget 1404, the service provided by the individual 1406, the individual's contractor 1408, first and last name 1410, email address 1412, position 1414, contact numbers 1418, edit widget 1420, and delete widget 1422. Additionally, interface 1400 can include widgets for adding new contacts to the contact list 1425, and for copying selected contacts to a different location or operation 1426. List of contact lists 1428 may include a listing of all contact lists for various locations that are present in system 100. The user can select a desired location from list of contact lists 100 to display the corresponding contact list for that location.

Helicopters

System 100 may include the capability to create, edit and manage helicopter manifests, and to create, manage and book helicopter flights and helicopter flight hours. Such capabilities can allow users of system 100 to track helicopters and personnel as they move between various locations. Additionally, system 100 can allow users to track the weights of all items and personnel to be loaded aboard helicopters, and thereby determine how many flights may be necessary to transfer all desired personnel and items between various departure and destination points.

To enter a new helicopter flight into system 100, a helicopter coordinator may create a new flight through the system for a particular helicopter, create a flight number for the new flight, and enter the point of origin, final destination, and all intermediate stops that the helicopter is expected to make. System 100 can allow for multiple-destination helicopter flights, and can generate multiple manifests for each flight, with each of such manifests corresponding to a single point of origin and a single destination. Thus, for example, for a helicopter flight to rig C from port A via platform B, the corresponding flight number may have a plurality of manifests associated therewith: a manifest for personnel and equipment headed from port A to platform B, a manifest for personnel and equipment headed from port A to rig C, and a manifest for personnel and equipment headed from platform B to rig C. It should be appreciated that the potential amount of manifests associated with each flight can increase with the amount of stops for that particular flight.

Various users may book personnel on helicopter flight manifests. For example, for personnel going offshore, a service company may use system 100 to make flight booking requests for the particular individuals that are to go offshore, stating the point of origin, destination, and any other pertinent information. Once the flight bookings are made, system 100 can display the individuals as “in queue” on the helicopter coordinator's outbound working helicopter manifests. The helicopter coordinator can then select certain individuals and add them to the helicopter manifests of a desired helicopter. As another example, for personnel traveling from an offshore location back to port, a rig materials man, a platform materials man, or radio operator (or any other user with the appropriate permissions) may use system 100 to make flight bookings for the particular individuals that are to return onshore, stating the point of origin, destination, and any other pertinent information. System 100 may limit the particular individuals that may be selected for booking solely to the individuals present on the particular offshore location's personnel on board list. This can promote consistency and reduce errors in personnel tracking, by ensuring that only individuals that are present at a location can be listed as departing that location. The selected individuals can then be booked onto helicopter manifests for any flight that is flying between the same locations as the point of origin and destination of the listed individuals. Once such individuals are booked on a helicopter manifest, and the status of the manifest is changed to “departed,” system 100 can remove the particular individuals from the offshore location's personnel on board list.

Helicopter manifests can have a status of “working,” “final,” “departed,” and “landed.” Working manifests are manifests that have not yet been finalized; thus, a user can add and remove equipment and personnel from the working manifests. Personnel and equipment that are “in queue” can be shown with working manifests, so as to allow the user to transfer queued personnel and equipment from the queue list to the manifest and vice versa. Final manifests correspond to manifests where the booking process has been completed, and therefore the user can be prevented from adding or removing any personnel or equipment from the final manifest. A final manifest can be reverted to a working manifest, if necessary. A departed manifest status indicates that the flight corresponding to the manifest has left the location. If the location is an offshore location such as a rig or a platform, system 100 may remove the personnel and equipment that are listed on the departed helicopter manifest from the personnel on board list and inventory list for that offshore location. A landed manifest status indicates that the flight corresponding to the manifest has landed at its final destination. If the final destination is an offshore location such as a rig or a platform, system 100 may add the personnel and equipment that are listed on the helicopter manifest to the personnel on board list and inventory list for that offshore location.

When a user changes the status of a manifest to “departed” or “landed,” system 100 may prompt the user to enter the time and date on which the helicopter departed a location or landed at its destination. System 100 may provide the current time and date as the default value for the time and date entry field. System 100 can utilize the departure times and landing times to calculate the amount of flight hours for a particular helicopter. The flight hour amounts may then be used by system 100 to calculate billing amounts for the services provided by each helicopter. Flight hours may be viewed for any desired period.

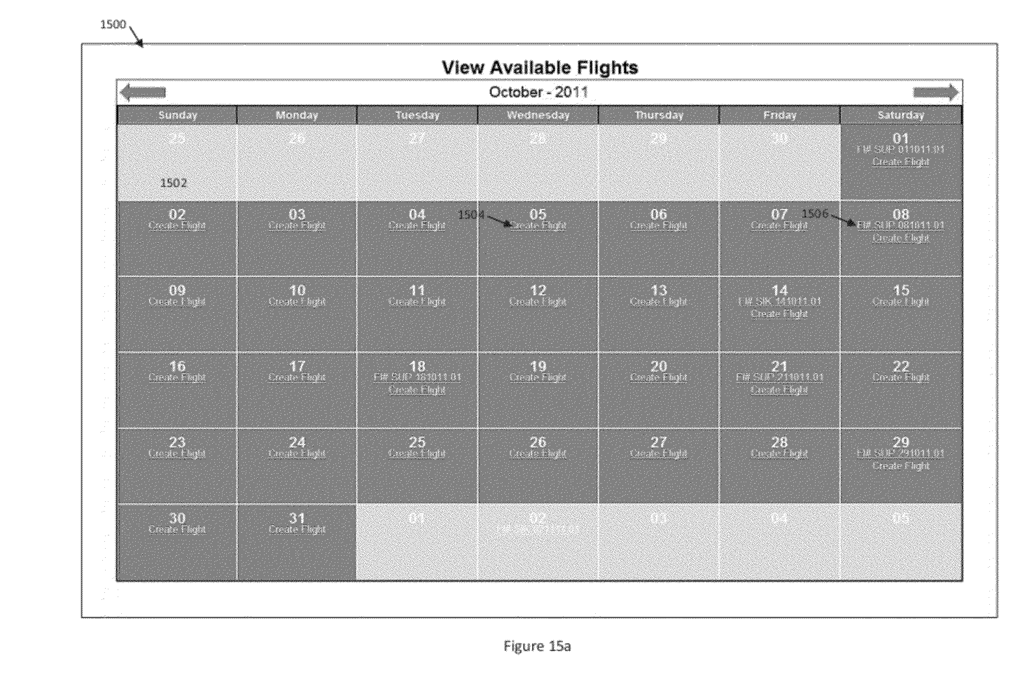

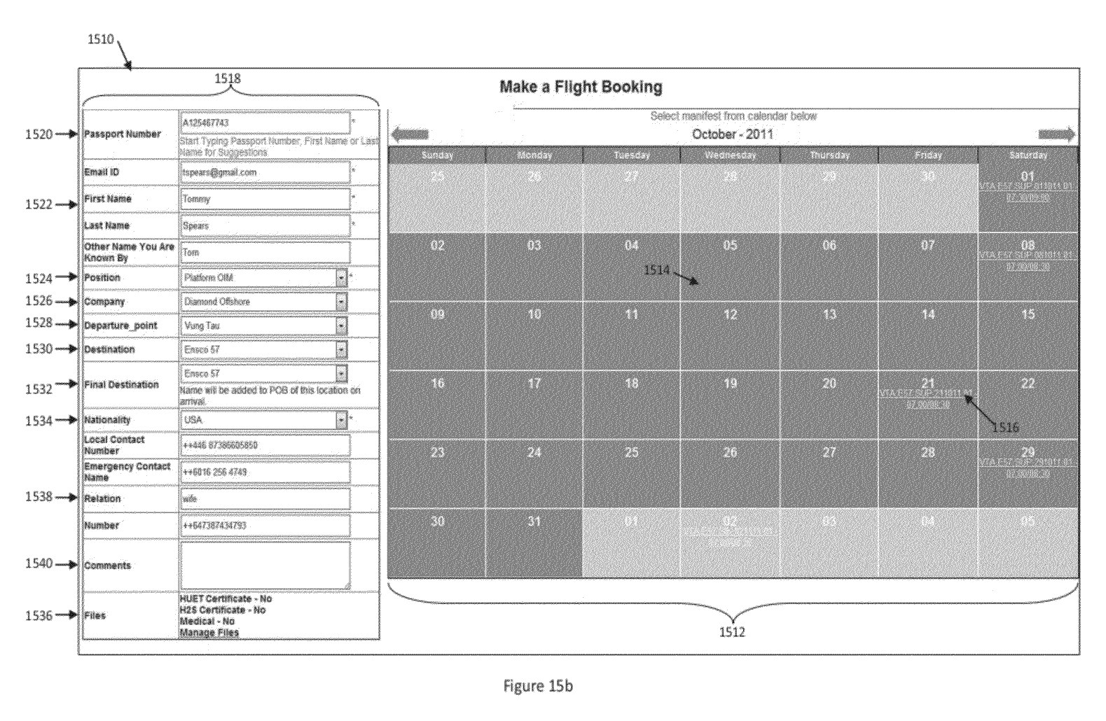

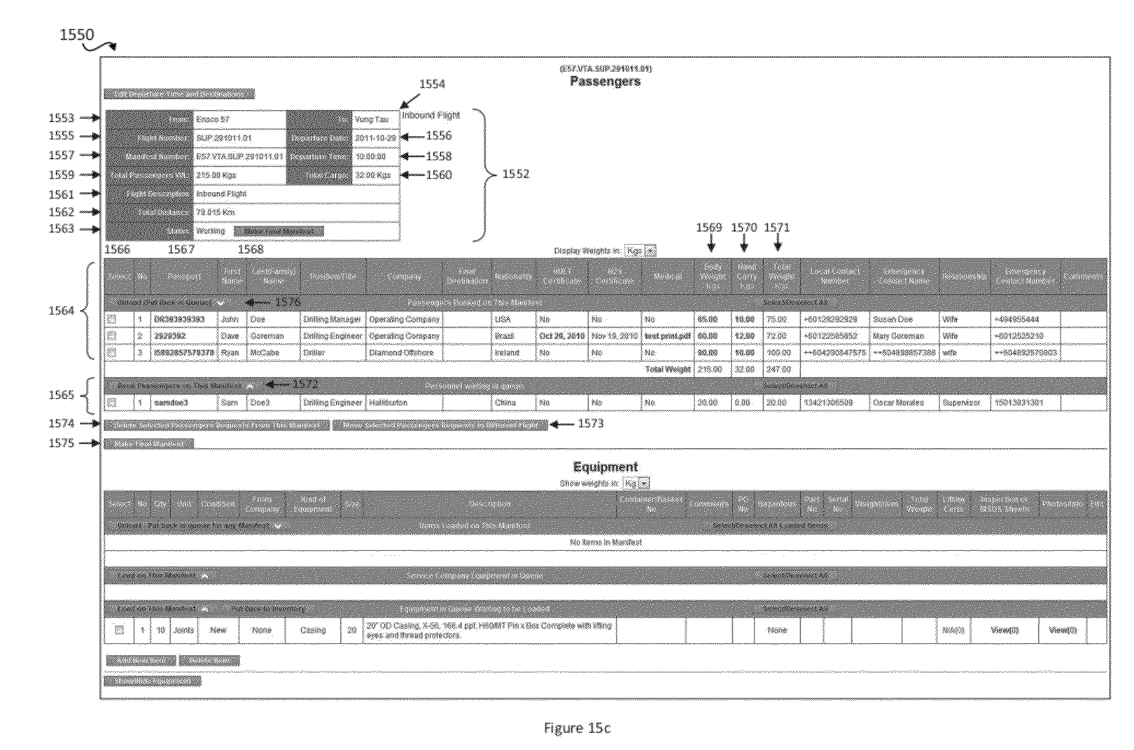

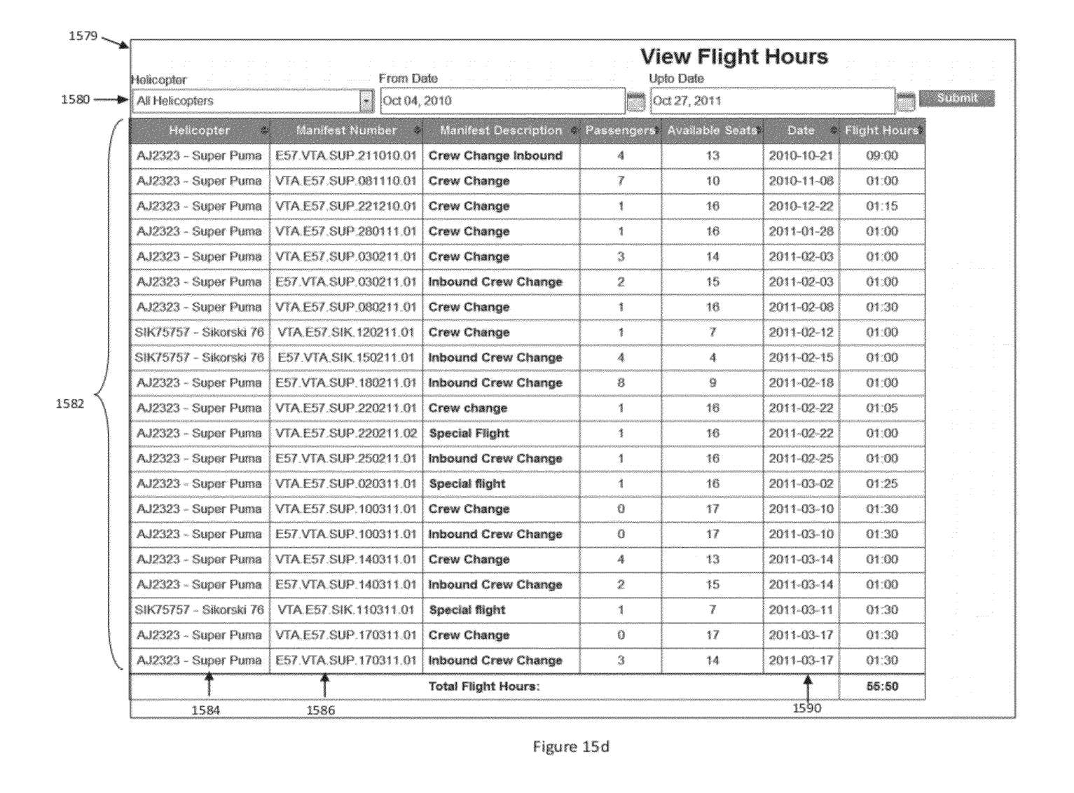

FIG. 15a shows an exemplary available flights interface 1500 of logistics management system 100. Available flights interface 1500 may be displayed in a calendar month format, with each day of the month displayed in a separate cell 1502. Each cell 1502 may include a create flight widget 1504, as well as links 1506 to all flights that have been entered into system 100 and that are taking place on that particular day. A user may select a flight link 1506 to view a helicopter manifest for that particular flight. A user may also select create flight widget 1504 to enter a new flight into system 100.

FIG. 15b shows an exemplary flight booking interface 1510 of logistics management system 100. Flight booking interface 1510 can include a calendar portion 1512 and a booking details portion 1518. Calendar portion 1512 may be displayed in a calendar month format, with each day of the month displayed in a separate cell 1514. Each cell 1514 may include a link 1516 to each of all flights that have been entered into system 100 and that are taking place on that particular day. A user may select a flight link 1516 to book an individual on that particular flight using booking details portion 1518. Booking details portion 1518 may include information pertaining to the individual that is to be booked on the particular flight. Such information may include passport number 1520, name 1522, position 1524, company 1526, point of departure 1528, destination 1530, final destination 1532, nationality 1534, safety certificates 1536, emergency contact information 1538 and comments 1540. Once a user enters the requisite information, system 100 may add the individual to the manifest of the selected helicopter flight, thereby booking the individual on that flight.

FIG. 15c shows an exemplary helicopter manifest interface 1550 for a logistics management system 100. FIG. 15c shows a “working” manifest, that is, a helicopter manifest that has not been finalized. Helicopter manifest interface 1550 may include helicopter details list 1552, passenger list 1564 and queue list 1565. Helicopter details list 1552 may display information pertinent to the helicopter for which the particular manifest is being viewed. Such information may include departure point 1553, destination 1554, flight number 1555, departure date 1556, manifest number 1557, departure time 1558, flight description 1561, calculated total passenger weights 1559, total calculated cargo weight 1560 and any other pertinent information. Passenger list 1564 and queue list 1565 may include, for each passenger displayed therein, select widget 1566, passport number 1567, passenger name 1568, and any other information pertaining to the individual that was entered via flight booking interface 1510. Lists 1564, 1565 may further include, for every passenger displayed therein, information regarding passenger body weight 1569, hand carry weight 1570 and total weight for booked passengers 1571. The weight information may allow users of system 100 to ascertain whether the loadout of a particular helicopter has exceeded that helicopters maximum weight capacity. Additionally, helicopter manifest interface 1550 may have action widgets such as: book queued passengers on flight 1572, move passengers back to queue 1576, delete passengers from manifest 1574, move passengers to a different flight 1573, and finalize manifest 1575. Thus, a user may select a passenger using the passenger's corresponding select widget 1566, and then execute an action using one of the action widgets. For example, in order to transfer a passenger from the queue to the helicopter manifest, a user can select the passenger in queue list 1565, then select book queued passengers widget 1572. A similar process can be followed to remove a passenger from the helicopter manifest, or to execute any other action via the action widgets.

FIG. 15d shows an exemplary flight hours interface 1579 for a logistics management system 100. Flight hours interface 1579 can display flight hours for all helicopters entered into system 100, or for any desired helicopter or group of helicopters entered into system 100. Flight hours interface 1579 can also limit the display of flight hours to a desired date range. These parameters may be controlled by a group of widgets 1580 provided within flight hours interface 1579. Flight hours interface 1579 may further include flight list 1582. For every flight displayed therein, flight list 1582 may include helicopter name 1584, manifest number 1586, and flight hours 1590. Flight list 1582 may further display total flight hours 1592 for all flights displayed therein.

Personnel on Board Lists and Look-Ahead Lists

Logistics management system 100 can include the capability to create and manage personnel on board lists. Personnel on board lists can be used to track the personnel that are on board a particular offshore location, such as a rig or a platform. Such lists may also be useful in emergency or evacuation procedures, as well as to quickly obtain a listing of all individuals present at an offshore location.

System 100 can gather information from boat manifests and helicopter manifests to facilitate the management of personnel on board lists. For example, personnel may be booked on a manifest of a boat or helicopter traveling to an offshore location. Once the boat or helicopter arrives at the location, a user may select the personnel from the boat or helicopter manifest and move the personnel to the personnel on board list for the particular location. System 100 may then remove the selected personnel from the manifest and add them to the offshore location's personnel on board list. Similarly, a user can add personnel that are present on an offshore location to a manifest of a boat or helicopter that is leaving the particular location. System 100 may then remove the selected personnel from the personnel on board list of the offshore location once the manifest status has been changed to “departed”. System 100 can therefore reduce errors in personnel tracking and ensure that the locations of all individuals are updated within the system in real time.

System 100 can further provide look-ahead and look-backwards capabilities for personnel on board lists. System 100 may gather information from boat manifests, helicopter manifests, and offshore-to-onshore manifests to determine when individuals are expected to arrive at a location, how long the individuals are expected to stay at a location, and when individuals are expected to leave a location. Thus, for example, if an individual is booked on a helicopter flight to Rig A on a certain date, that individual will appear on the personnel on board manifest for Rig A starting with and subsequent to the certain date. Similarly, once that individual is booked, for example, on a boat manifest that departs Rig A on a second date, he individual will be removed from the personnel on board manifest for Rig A on the second date. System 100 may thus provide a prognosis for which personnel will be at a particular location at a given time in the future. System 100 may further provide a record of which personnel were onboard a particular location at a given time in the past, as well as a roster of which personnel are presently onboard a particular location.

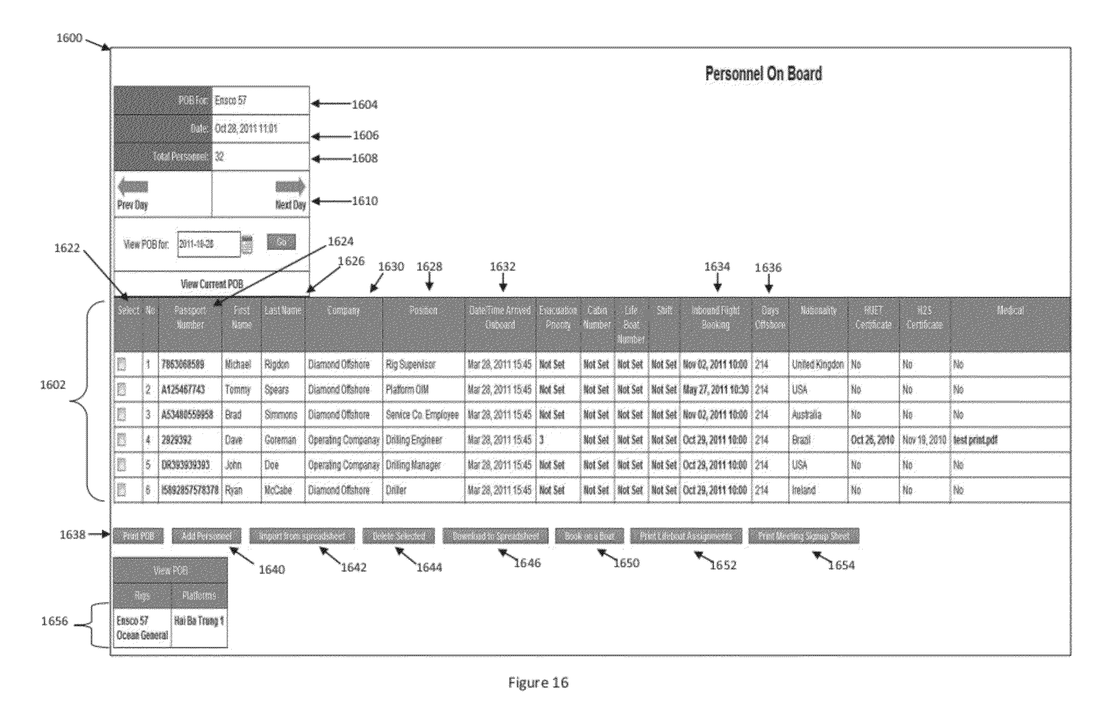

FIG. 16 shows an exemplary personnel on board interface 1600 of a logistics management system 100. Personnel on board interface 1600 may include a POB details list 1602, a total personnel list 1602, and a location list 1656. POB details list 1602 may include details about the personnel on board list that is being viewed, such as location name 1604, date 1606, total personnel 1608, and date control widgets 1610. The user may use the date control widgets to select the date for which a personnel on board list is being displayed. Personnel list 1602 may include, for every individual listed thereon, select widget 1622, passport number 1624, name 1626, position 1628, company 1630, arrival onboard date and time 1632, book flight widget 1634, days offshore counter 1636, and any other pertinent information, including contact information and weight information, substantially as described above. Personnel on board interface can also include action widgets, such as print POB 1638, add personnel 1640, import from spreadsheet 1642, delete selected 1644, and download to spreadsheet 1646. Location list 1656 can display all offshore locations, such as rigs and platforms, that are entered into system 100. The user may select any desired location to view the corresponding personnel on board lists and utilize the look-ahead and look-backward capabilities of system 100.

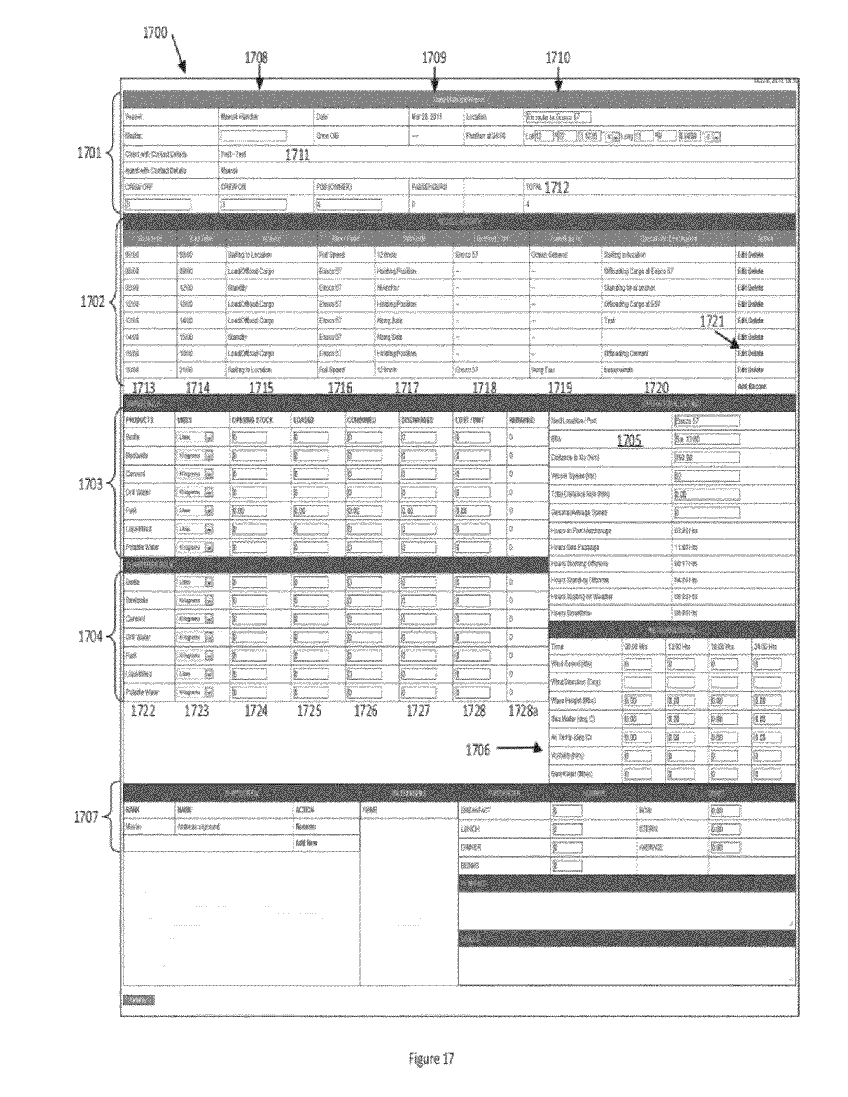

FIG. 17 shows an exemplary boat daily activity report interface 1700 of a logistics management system 100. Boat daily activity report interface 1700 may include a vessel summary list 1701, a daily vessel activity report 1702, an vessel owner bulk materials-on-board list 1703, a vessel charterer bulk materials-on-board list 1704, an operational details list 1705, a meteorological information list 1706, and a boat passenger and crew list 1707. Vessel summary list 1701 may include vessel name 1708, report date 1709, present location 1710, client and agent contact details 1711 and total passengers on board list 1712. The daily vessel activity report list 1702 may include activity start times 1713, activity end times 1714, activity descriptions 1715, major activity codes 1716, activity sub codes 1717, traveling-from information 1718, traveling-to information 1719 and operations descriptions 1720. In addition the daily activity report interface 1702 may have edit, delete and add widgets 1721 to edit a current activity, delete an activity or add a new activity to the daily activity report.

The vessel owner's bulk materials-on-board list may include a products listing 1722, units widget 1723, opening stock input 1724, loaded input 1725, consumed input 1726, discharged input 1727, cost/unit input 1728 and remaining-on-board calculation 1728a. The functionality of the charterer bulk materials-on-board list 1704 may be substantially similar to the vessel owner's bulk materials-on-board list 1703 with similar inputs and displays.

The operational detail list 1705 may have next location/port 1729, estimated time of arrival 1730, distance to go 1731, vessel speed 1732, total distance run 1733, general average speed 1734 and several statistics outputs 1728 that will be generated by system 100. Statistics outputs may include hours in port, hours spent in sea passage, total hours working offshore, hours spend on standby offshore, hours waiting on weather and hours down time. Such information may be used, for example by vessel charterers, to determine the performance quality of the vessels. Daily meteorological interface 1706 may be included to document the daily offshore weather report. This report may include wind speed and direction, wave height, water temperature, visibility and barometric pressure, and any other desired information. Vessel daily personnel on board interface 1707 may include the names and position information for crew hands on board, names of passengers on board, and the total number of meals consumed by passengers on board. Vessel draft information may also be shown. Information collected in boat daily activity reports may be combined with information in the boat manifests to compile statistical information, such as, for example, ton-miles moved per day, total down time for boats, and number of people moved by boats.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for logistics management, comprising:
managing and tracking locations;
managing and tracking vehicles;
managing and tracking bulk materials;
managing and tracking materials and equipment;
managing boat manifests;
managing service company manifests;
managing and tracking rental equipment;
managing operations look-ahead timelines;
managing callout lists;
managing planning files;
managing contact lists;
managing helicopters;
managing boat daily activity reports; and
managing personnel information.

2. The method of claim 1, wherein managing and tracking locations further comprises:
registering a location in a database;
entering data pertaining to the location in the database; and
monitoring the activity of each registered location.

3. The method of claim 1, wherein managing and tracking vehicles further comprises:
registering a vehicle in a database;
entering data pertaining to the vehicle in the database; and
tracking the location and activity of each registered vehicle.

4. The method of claim 1, wherein managing bulk materials further comprises:
displaying inventory lists of bulk materials;
accepting and converting between units of mass and volume based on an input of a density of a particular bulk material;
tracking incoming and outgoing quantities of bulk materials; and
calculating and tracking transfer losses of bulk materials.

5. The method of claim 1, wherein managing boat manifests further comprises:
creating a manifest for a vessel, wherein the manifest comprises one or more of location details, transportation details and inventory lists;
selecting materials or personnel for transfer to a desired location;
setting the status of the selected materials or personnel as in-queue for the desired location;
displaying the in-queue materials or personnel on manifests of all vessels departing to the desired location;
adding the in-queue materials or personnel to a boat manifest of a vessel departing to the desired location;
finalizing the boat manifest;
removing materials or personnel from the boat manifest upon the vessel's arrival to an inventory of the desired location.

6. The method of claim 1, wherein managing materials and equipment further comprises:
tracking and managing warehouse inventories for onshore locations;
tracking and managing warehouse inventories for offshore location; and
tracking and managing floating stock inventories for vessels.

7. The method of claim 1, wherein managing load-out data further comprises:
creating a loadout list having designated items to be sent from a location to a desired destination;
displaying the designated items on manifests of all vessels departing to the desired destination from the location;
selecting desired designated items for shipment on a desired vessel; and
adding the selected items to the desired vessel's manifest.

8. The method of claim 1, wherein managing service company manifests further comprises:
creating data lists that describe the items to be sent by a service company;
creating data lists that describe items that are in queue to be sent by a service company; and
creating data lists that describe items that are in transit from a service company.

9. The method of claim 1, wherein managing rental equipment further comprises:
designating rental status to certain items;
designating a rental rate for each item;
tracking the status of rental items; and
managing billing for the rental items.

10. The method of claim 1, wherein managing operations look-ahead timelines further comprises:
creating a schedule of future expected operations;
creating a timeline of the expected durations of the future expected operations; and
cross-referencing the future expected operations schedule and the expected durations timeline with actual departure and arrival dates of personnel and equipment.

11. The method of claim 1, wherein managing call-out lists further comprises:
designating items as requested to be sent to a desired location and delivered by a certain date;
displaying the designated items on a list;
marking items on the list that have been loaded for shipment to the desired location; and
removing marked items from the list that have been delivered to the desired location.

12. The method of claim 1, wherein managing planning files further comprises:
uploading documents related to the planning and performing of onshore and offshore operations;
storing the documents in an internet-accessible database;
displaying the documents; and
editing the documents when changes are necessary.

13. The method of claim 1, wherein managing contact lists further comprises:
creating a database containing personal and contact information for all personnel assigned to a particular location, vehicle, or operation;
editing the information when changes are necessary; and
displaying the information.

14. The method of claim 1, wherein managing helicopters further comprises:
registering a flight for a desired helicopter;
entering applicable flight data for the flight;
determining a point of departure, a destination, and intermediate stops for the flight;
adding desired personnel to a flight manifest for the desired helicopter;
adding desired inventory items to a flight manifest for the desired helicopter;
tracking the locations of the personnel and the inventory items;
determining the number of flights necessary to transport all necessary personnel and inventory items to a particular location; and
logging, organizing, and displaying flight hours for each created flight.

15. The method of claim 1, wherein managing personnel information further comprises:
creating lists of all personnel located at a particular offshore location;
transferring personnel data to a helicopter or boat manifest from a particular offshore location when personnel travel to a different location;
transferring personnel data from a helicopter or boat manifest to a particular offshore location when personnel arrive at a different location;
tracking the location of personnel;
checking the records to determine when certain personnel will arrive at a particular location in the future; and
checking the records to determine when certain personnel arrived or departed a particular location in the past.

16. A logistics management system, comprising:
a location and vehicle management capability;
a bulk materials management capability;
a boat manifest management capability;
a materials management capability;
a load-out list management capability;
a service-company manifest management capability;
a rental equipment management capability;
an operations look-ahead timeline management capability;
a call-out list management capability;
a planning files management capability;
a contact lists management capability;
a helicopter management capability;
a boat daily activity report capability; and
a personnel management capability.

17. The system of claim 16, further comprising a plurality of accounts that can be registered under a plurality of operating companies, countries, and divisions.

18. The system of claim 16, wherein the system can be accessed by various classes of users and super-users.

19. The system of claim 16, wherein the system can be accessed via an interne connection.

20. The system of claim 16, further comprising a plurality of permissions pages comprising:
separation of different user classes;
permissions for access to oil rig location data;
permissions for access to onshore location data;
permissions for access to boat daily activity reports; and
permissions for access to offshore location data.

21. The system of claim 16, wherein the location and vehicle management capability further comprises:
means for registering locations and vehicles in a database;
means for entering data pertaining to the locations and vehicles;
means for monitoring the activity of the locations; and
means for monitoring the location and activity of the vehicles.

22. The system of claim 16, wherein the bulk materials management capability further comprises:
means for displaying inventory lists of bulk materials;
means for converting between units of mass and volume for the bulk materials based on the density of the bulk materials;
means for tracking incoming and outgoing quantities of bulk materials; and
means for calculating and tracking transfer losses of bulk materials.

23. The system of claim 16, wherein the boat manifest management capability further comprises:
means for creating a manifest for a vessel;
means for selecting materials or personnel for transfer to a desired location;
means for setting the status of the selected materials or personnel as in-queue for the desired location;
means for adding the in-queue materials or personnel to a boat manifest of a vessel departing to the desired location;
means for removing materials or personnel from the boat manifest upon the vessel's arrival to the desired location and transferring the materials or personnel to the personnel-on-board list and inventory list of the desired location.

24. The system of claim 16, wherein the materials management capability further comprises:
means for tracking and managing warehouse inventories for onshore locations;
means for tracking and managing warehouse inventories for offshore location; and
means for tracking and managing floating stock inventories for vessels.

25. The system of claim 16, wherein the load-out list management capability further comprises:
means for designating items to be sent from a location to a desired destination;
means for displaying the designated items on manifests of all vessels departing to the desired destination from the location;
means for selecting desired designated items for shipment on a desired vessel; and
means for adding the selected items to the desired vessel's manifest.

26. The system of claim 16, wherein the service-company manifest management capability further comprises:
means for creating data lists that describe the items to be sent by a service company;
means for creating data lists that describe items that are in queue to be sent by a service company; and
means for creating data lists that describe items that are in transit from a service company.

27. The system of claim 16, wherein the rental equipment management capability further comprises:
means for designating rental status to certain items;
means for designating a rental rate for each item;
means for tracking the status of rental items;
means for tracking the movement history of rental items; and
means for managing billing for the rental items.

28. The system of claim 16, wherein the operations look-ahead timeline management capability further comprises:
means for creating a schedule of future expected operations;
means for creating a timeline of the expected durations of the future expected operations; and
means for cross-referencing the future expected operations schedule and the expected durations timeline with actual arrival and departure dates of personnel and equipment.

29. The system of claim 16, wherein the call-out list management capability further comprises:
means for designating items as requested to be sent to a desired location and delivered by a certain date;
means for displaying the designated items on a list;
means for marking items on the list that have been loaded for shipment to the desired location; and
means for removing marked items from the list that have been delivered to the desired location.

30. The system of claim 16, wherein the planning files management capability further comprises:
means for uploading documents related to the planning and performing of onshore and offshore operations;
means for storing the documents in a database;
means for displaying the documents; and
means for editing the documents when changes are necessary.

31. The system of claim 16, wherein the contact lists management capability further comprises:
means for creating a database containing personal and contact information for all personnel assigned to a particular location, vehicle, or operation; and
means for editing the information when changes are necessary.

32. The system of claim 16, wherein the helicopter management capability further comprises:
means for registering a flight for a desired helicopter;
means for entering applicable flight data for the flight;
means for determining a point of departure, a destination, and intermediate stops for the flight;
means for adding desired personnel to a flight manifest for the desired helicopter;
means for adding desired inventory items to a flight manifest for the desired helicopter;
means for tracking the locations of the personnel and the inventory items;
means for determining the number of flights necessary to transport all necessary personnel and inventory items to a particular location; and
means for logging, organizing, and displaying flight hours for each created flight.

33. The system of claim 16, wherein the personnel management capability further comprises:
means for creating lists of all personnel located at a particular offshore location;
means for transferring personnel data to a helicopter or boat manifest from a particular offshore location when personnel travel to a different location;
means for transferring personnel data from a helicopter or boat manifest to a particular offshore location when personnel arrive at a different location;
means for tracking the location of personnel;
means for checking the records to determine when certain personnel will arrive at a particular location in the future; and
means for checking the records to determine when certain personnel arrived or departed a particular location in the past.
